(19) United States
(12) Patent Application Publication
(10) Pub. No.: US 2025/0039915 A1
(43) Pub. Date: Jan. 30, 2025

(54) Interference Awareness Procedures for WLAN Systems

(71) Applicant: InterDigital Patent Holdings, Inc., Wilmington, DE (US)

(72) Inventors: Hanqing Lou, Syosset, NY (US); Zinan Lin, Basking Ridge, NJ (US); Xiaofei Wang, North Caldwell, NJ (US); Mahmoud Saad, Montreal (CA); Rui Yang, Greenlawn, NY (US)

(73) Assignee: InterDigital Patent Holdings, Inc., Wilmington, DE (US)

(21) Appl. No.: 18/785,586

(22) Filed: Jul. 26, 2024

Related U.S. Application Data
(60) Provisional application No. 63/516,110, filed on Jul. 27, 2023.

(51) Int. Cl. H04W 72/541

(52) U.S. Cl. CPC H04W 72/541

(57) ABSTRACT

Systems and methods are described for interference awareness in wireless communication systems. A wireless station (STA) may detect an interference event comprising a transmission that will interfere or is interfering with a communication session of the STA with a second device, such as an access point (AP). The first device may transmit, to the second device, an identification of the interference event. The first device may receive, from the second device, a selection of an operation mode of a plurality of modes, transmitted responsive to receipt of the identification of the interference event. The first device may continue the communication session, with the second device, utilizing the selected operation mode.

### CROSS-REFERENCE TO RELATED APPLICATIONS

This application claims the benefit of U.S. Provisional Patent App. No. 63/516,110, filed Jul. 27, 2023, which is incorporated by reference herein in its entirety.

### BACKGROUND

Because wireless communications utilize a common medium, signal transmissions may be prone to interference, particularly as the number of devices utilizing the wireless network increase. Interference can cause increased noise, decreased throughput, signal loss, or other harmful effects. Mitigation attempts can include error correction algorithms, retransmission algorithms, or other such systems.

### SUMMARY

Systems and methods are described for interference awareness in wireless communication systems. A first device, such as a wireless station (STA), may detect an interference event comprising a transmission that will interfere or is interfering with a communication session of the STA with a second device, such as an access point (AP). The first device may transmit, to the second device, an identification of the interference event. The first device may receive, from the second device, a selection of an operation mode of a plurality of modes, transmitted responsive to receipt of the identification of the interference event. The first device may continue the communication session, with the second device, utilizing the selected operation mode.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an illustration of an embodiment of a medium access control (MAC) frame format;

FIG. 3 is a table listing variants of high throughput (HT) control field parameters, according to some embodiments;

FIG. 4 is an illustration of an embodiment of an aggregated control (A-Control) subfield of the high efficiency (HE) variant HT control field;

FIG. 5 is an illustration of an embodiment of a control field subfield;

FIG. 6 is a table listing values and lengths of a control information subfield, according to some embodiments;

FIG. 7 is an illustration of an embodiment of a control information subfield;

FIG. 8 is an illustration of another embodiment of a control information subfield;

FIG. 9 is an illustration of example characteristics of an interfering signal;

FIG. 10 is an illustration of signal transmissions for an embodiment of an interference awareness procedure;

FIG. 11 is an illustration of signal transmissions for another embodiment of an interference awareness procedure;

FIG. 12 is an illustration of signal transmissions for another embodiment of an interference awareness procedure;

FIG. 13 is an illustration of an embodiment of an interference awareness setup frame action field

FIG. 14 is an illustration of an embodiment of an interference awareness control field;

FIG. 15 is an illustration of an embodiment of an interference awareness parameter field;

FIG. 16 is a table listing interference type values, according to some embodiments;

FIG. 17 is an illustration of an embodiment of an interference instance information subfield;

FIG. 18 is an illustration of an embodiment of an interference awareness element subfield;

FIG. 19 is an illustration of signal transmissions for yet another embodiment of an interference awareness procedure;

FIG. 20 is an illustration of an embodiment of a control information subfield;

FIG. 21 is an illustration of an embodiment of an operation mode indication (OMI) field;

FIG. 22 is an illustration of an embodiment of an interference awareness procedure;

FIG. 23 is an illustration of signal transmissions for yet another embodiment of an interference awareness procedure;

FIG. 24 is an illustration of an embodiment of a sounding dialog token field;

FIG. 25 is a table listing an encoding of sounding dialog token numbers, according to some embodiments;

FIG. 26 is an illustration of an embodiment of an enhanced STA Info field format for an enhanced EHT NDP Announcement frame;

FIG. 27 is a table listing an encoding of interference report types, according to some embodiments;

FIG. 28 is a table listing an encoding of modified EHT Action field values, according to some embodiments; and

FIG. 29 is a table listing an encoding of modified compressed beamforming/CQI frame Action field values, according to some embodiments.

### DETAILED DESCRIPTION

Table 1 is a non-exhaustive list of acronyms that may be used herein.

TABLE 1

| | |
|---|---|
| gNB | NR NodeB |
| ACK | Acknowledgement |
| AP | Access Point |
| BSS | Basic Service Set |
| CCA | Clear Channel Assessment |
| CDM | Code Division Multiplexing |
| CDMA | Code Division Multiple Access |
| CE | Control Element |
| CSMA/CA | Carrier Sense Multiple Access with Collision Avoidance |
| DL | Downlink |
| DS | Distribution System |
| FDM | Frequency Division Multiplexing |
| FDMA | Frequency Division Multiple Access |
| HT | High Throughput |
| IEID | Interference Event ID |
| IFFT | Inverse Fast Fourier Transform |
| OMI | Operation Mode Indication |
| LTE | Long Term Evolution e.g. from 3GPP LTE R8 and up |
| MAC | Medium Access Control |
| MCS | Modulation and Coding Scheme |
| MIMO | Multiple Input Multiple Output |
| MLD | Multi-Link Device |
| MLE | Multi-Link Element |
| MLO | Multi-Link Operation |
| MTC | Machine-Type Communications/Meter Type Control |
| MU-MIMO | Multi-User Multiple Input Multiple Output |
| NACK | Negative ACK |
| NAV | Network Allocation Vector |
| NR | New Radio |
| OFDM | Orthogonal Frequency-Division Multiplexing |
| OFDMA | Orthogonal Frequency-Division Multiple Access |
| PDU | Protocol Data Unit |
| PER | Packet Error Rate |
| PHY | Physical Layer |
| PRB | Physical Resource Block |
| PSS | Primary Synchronization Signal |
| RA | Random Access (or procedure) |
| RACH | Random Access Channel |
| RAN | Radio Access Network |
| RS | Reference Signal |
| RSRP | Reference Signal Received Power |
| RSSI | Received Signal Strength Indicator |
| RTT | Round-Trip Time |
| SC-FDMA | Single-Carrier Frequency Division Multiple Access |
| STA | Stations |
| TDM | Time-Division Multiplexing |
| TDMA | Time-Division Multiple Access |
| TRx | Transceiver |
| UE | User Equipment |
| UL | Uplink |
| VHT | Very High Throughput |
| WLAN | Wireless Local Area Networks and related technologies |
| | (IEEE 802.xx domain) |
| WTRU | Wireless Transmit/Receive Unit |

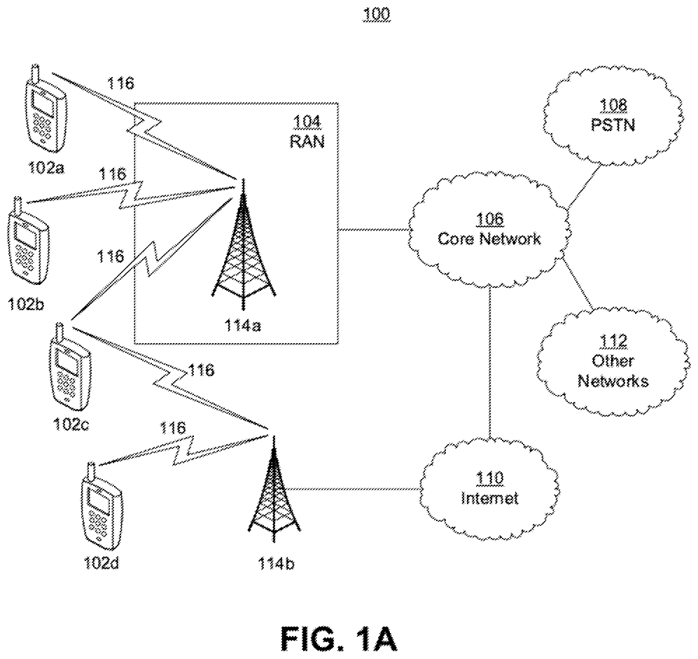

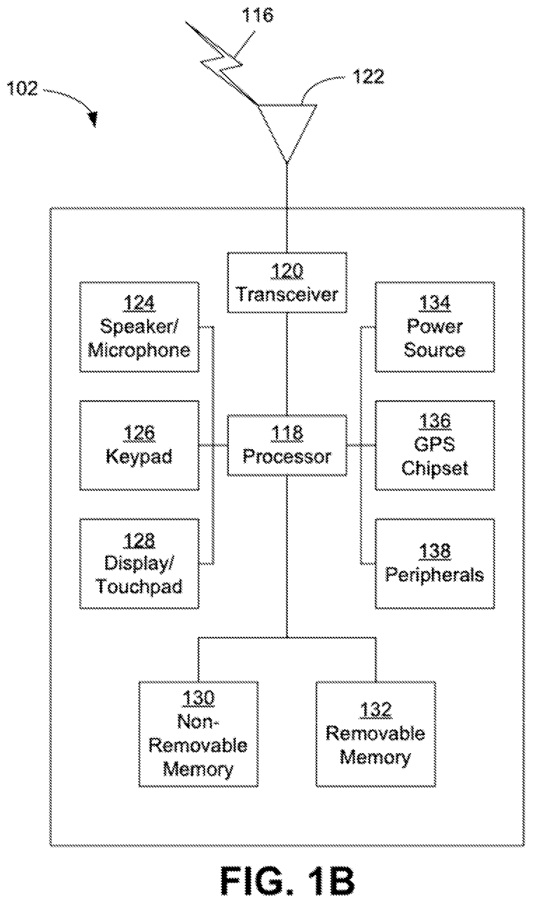

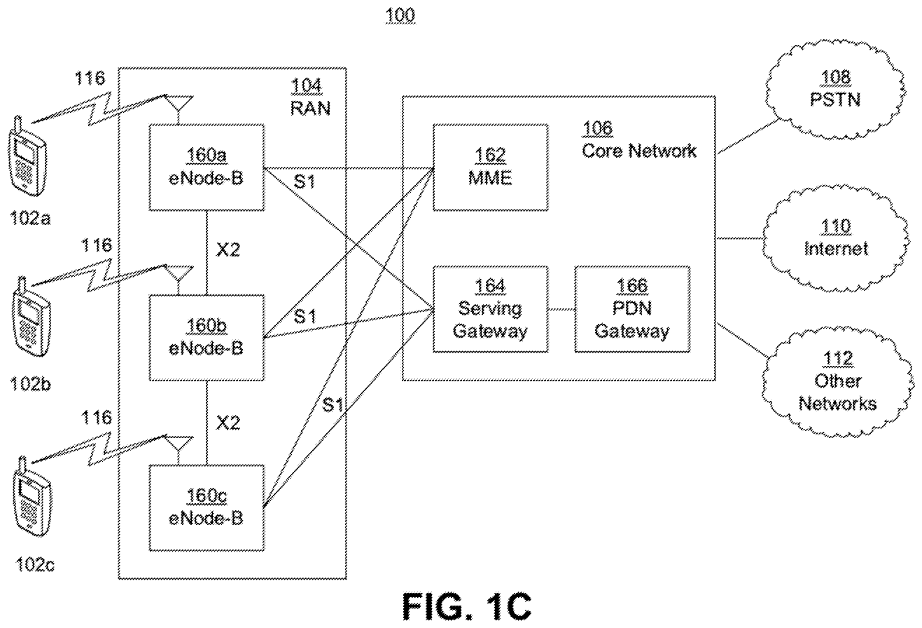

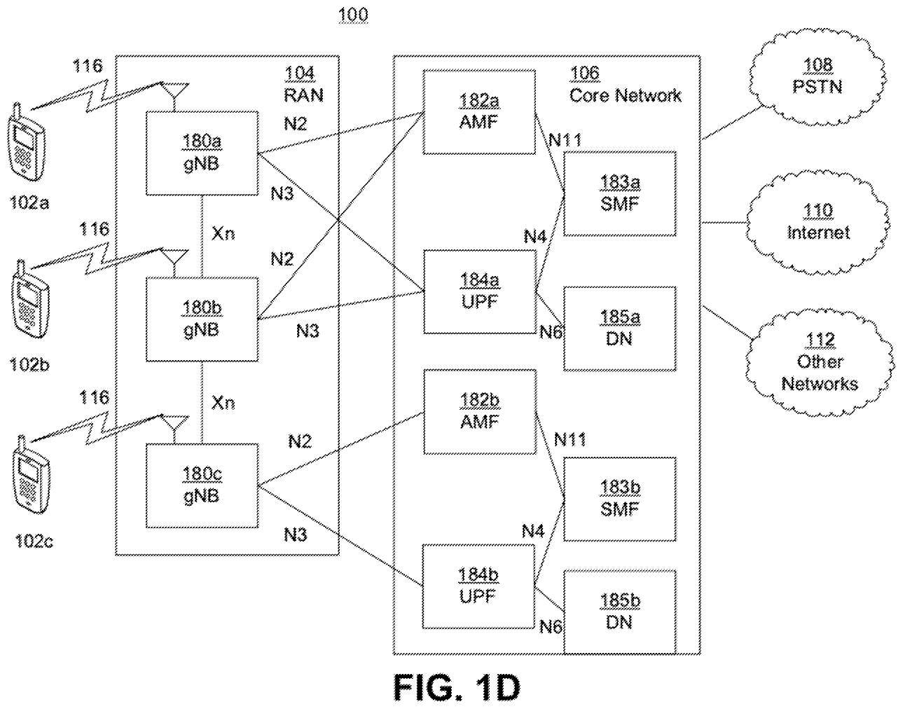

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A wireless local area network (WLAN) in Infrastructure Basic Service Set (BSS) mode has an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA.

Using the 802.11ac infrastructure mode of operation, the AP may transmit a beacon on a fixed channel, usually the primary channel. This channel may be 20 MHz wide, and is the operating channel of the BSS. This channel is also used by the STAs to establish a connection with the AP. The fundamental channel access mechanism in an 802.11 system is Carrier Sense Multiple Access with Collision Avoidance (CSMA/CA). In this mode of operation, every STA, including the AP, will sense the primary channel. If the channel is detected to be busy, the STA backs off. Hence only one STA may transmit at any given time in a given BSS.

In 802.11n, High Throughput (HT) STAs may also use a 40 MHz wide channel for communication. This is achieved by combining the primary 20 MHz channel, with an adjacent 20 MHz channel to form a 40 MHz wide contiguous channel.

In 802.11ac, Very High Throughput (VHT) STAs may support 20 MHz, 40 MHZ, 80 MHZ, and 160 MHz wide channels. The 40 MHZ, and 80 MHZ, channels are formed by combining contiguous 20 MHz channels similar to 802.11n described above. A 160 MHz channel may be formed either by combining 8 contiguous 20 MHz channels, or by combining two non-contiguous 80 MHz channels, this may also be referred to as an 80+80 configuration. For the 80+80 configuration, the data, after channel encoding, is passed through a segment parser that divides it into two streams. IFFT and time domain processing are done on each stream separately. The streams are then mapped on to the two channels, and the data is transmitted. At the receiver, this mechanism is reversed, and the combined data is sent to the MAC.

To improve spectral efficiency 802.11ac has introduced the concept for downlink Multi-User MIMO (MU-MIMO) transmission to multiple STAs in the same symbol's time frame, e.g. during a downlink OFDM symbol. The potential for the use of downlink MU-MIMO is also currently considered for 802.11ah. It is important to note that since downlink MU-MIMO, as it is used in 802.11ac, uses the same symbol timing to multiple STA's interference of the waveform transmissions to multiple STA's is not an issue. However, all STA's involved in MU-MIMO transmission with the AP must use the same channel or band, this limits the operating bandwidth to the smallest channel bandwidth that is supported by the STA's which are included in the MU-MIMO transmission with the AP.

The IEEE 802.11 UHR Study Group was formed in July 2022 to create a project authorization request (PAR) to create an 802.11 Task Group to standardize improved reliability of WLAN connectivity, reduce latencies, increase manageability, increase throughput consumption.

Millimeter wave (mmW or mmWave) operation may be implemented in one or more of the communication systems and/or by one or more devices of the communication systems described herein. Millimeter wave communications may be communications configured to operate in a millimeter band of a wireless spectrum. The millimeter band of the wireless spectrum may include the band of wireless spectrum with wavelengths between 10 millimeters (e.g. 30 GHZ) and 1 millimeter (e.g., 300 GHz). The millimeter band of a wireless spectrum may include extremely high frequency (EHF) band by the International Telecommunication Union (ITU).

Propagation distances at lower frequencies may travel up to a kilometer, while the higher frequency millimeter wave communications may travel within meters. Millimeter wave communications may travel by line of sight and may be blocked or significantly reduced by physical objects of interference. Millimeter wave communications may support relatively higher data rates than other forms of communication between devices in communication systems. The millimeter wave communications can be used to support higher bandwidth operations than other forms of communication, and particularly in areas with a greater number of users. Millimeter wave communications may be used to provide faster download speeds than other forms of wireless communications.

Due to the higher frequency of millimeter wave communications than other forms of wireless communication, the millimeter wave communications may experience a higher channel loss in response to interference. Communication devices implementing millimeter wave communication may implement techniques, such as beamforming, to increase transmission gains. Beamforming may be performed to account for certain directionality to enable performance of wireless communications in a given direction to increase transmission gains.

Beamforming is a technique uses directional signaling to improve the signal-to-noise ratio (SNR) of received signals, eliminate undesirable interference sources, and focus transmitted signals to specific locations. Beamforming may be applied to give directionality to each wireless communication link between two devices in a wireless communication system. For example, beamforming may be applied to each beam or communication link when a device is implementing MIMO wireless communications from multiple antennas to improve the SNR on each beam or communication link.

In some implementations, devices operating with mmWave operation may be multi-link operation (MLO)-capable devices and may have at least one active sub-7 GHz link. In one example, WIFI 7 and IEEE 802.11bn Ultra High Reliability (UHR) specifications may provide for MLO-capable devices operating in mmWave bands/communication links. MLO was introduced in 802.11be. MLO may allow for a STA to communicate with an AP or another base station over multiple frequency bands/communication links at the same time using multiple transceivers and/or antennas. The STA and the AP may select the frequency bands/communication links on which they are communicating. MLO may introduce link redundancy by having the transmitting device send the same data over two different frequency bands/communication links using two different transceivers. MLO may increase the maximum bandwidth over which data can be transmitted and/or overall throughput. MLO may also, or alternatively allow the STA and the AP to implement link aggregation to split data being communicated across the frequency bands/communication links. The transmitting device may transmit different data via different transceivers on different frequency bands/communication links.

MLO enables a non-AP multi-link device (MLD) to discover, authenticate, associate, and set up multiple links with an AP MLD. An AP (referred to as a reporting AP) affiliated with an AP MLD may advertise operating capabilities and operating parameters of another AP (referred to as a reported AP) affiliated with the same AP MLD by including Multi-Link Element. Each link enables channel access and frame exchanges between the non-AP MLD and the AP MLD based on the supported capabilities exchanged during association.

The discovery and association procedure may be done in a lower band/communication link. Scheduling and broadcast are from a lower band/communication link. Beamforming (BF) training with sector sweep (SS) is done in mmW band/communication link, but BF training sequence can be triggered or scheduled from a lower band and feedback can be provided in a lower band.

In many embodiments, an STA may be able to properly construct a subset of the frames specified in this clause for transmission and to decode a (potentially different) subset of the frames specified in this clause upon validation following reception. The particular subset of these frames that a STA constructs and decodes is determined by the functions supported by that particular STA. A STA may be able to validate every received frame using the frame check sequence (FCS) and to interpret certain fields from the MAC headers of all frames.

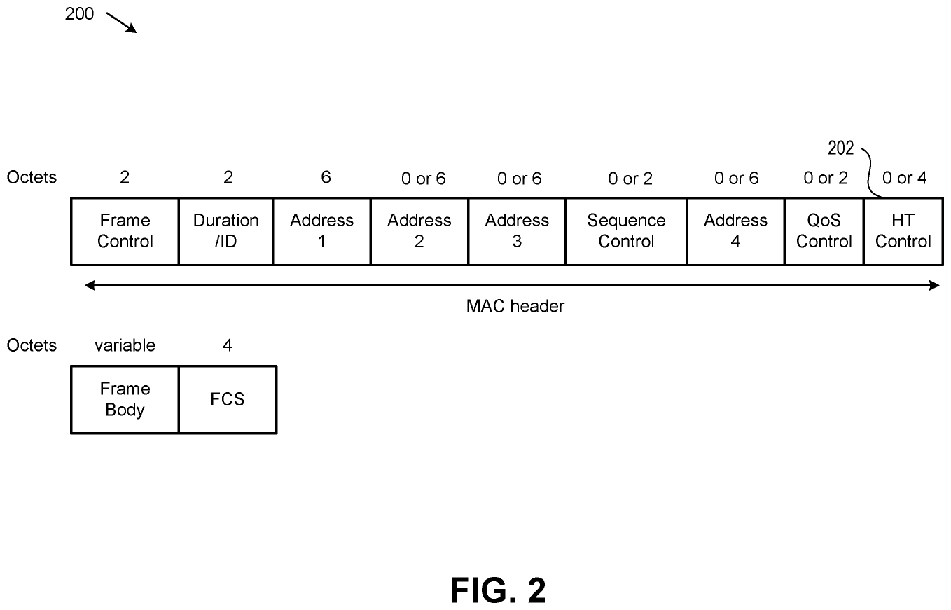

A STA may transmit frames using various frame formats, such as the format 200 illustrated in FIG. 2. The MAC frame format 200 comprises a set of fields that occur in a fixed order in all frames. FIG. 2 depicts the general MAC frame format 200 for protocol version 0 (PVO) MPDU.

The HT Control field 202 may be present in a Control Wrapper frame and is present in QoS Data, (802.11ax) QoS Null, and Management frames as determined by the +HTC subfield of the Frame Control field.

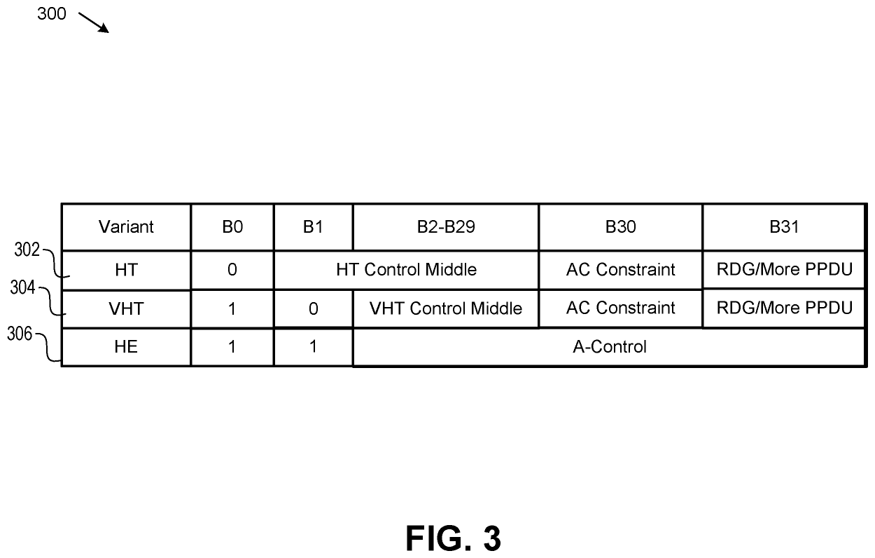

The HT Control field 202 transmitted by a by a Millimeter-Wave Multi-Gigabit (MMG) STA (e.g., non-China MMG STA) may have three variants. FIG. 3 shows a table 300 shows the HT variant 302, the VHT variant 304, and the HE variant 306. As shown in FIG. 3, the variant formats may be differentiated by the values of B0 and/or B1.

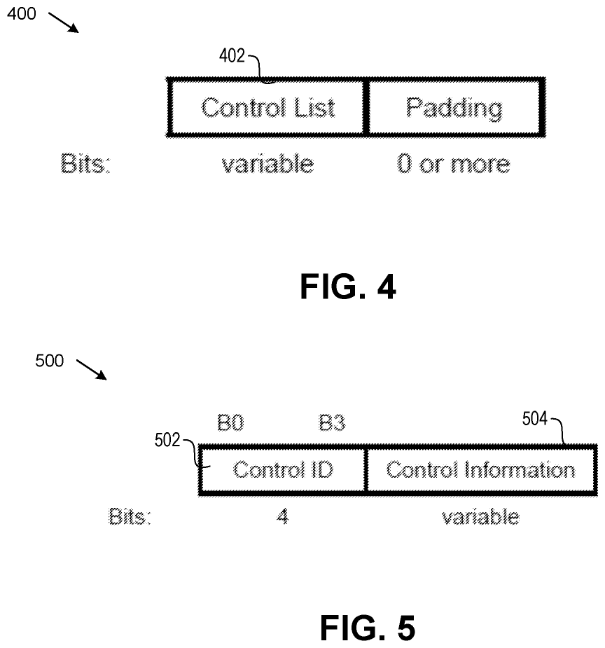

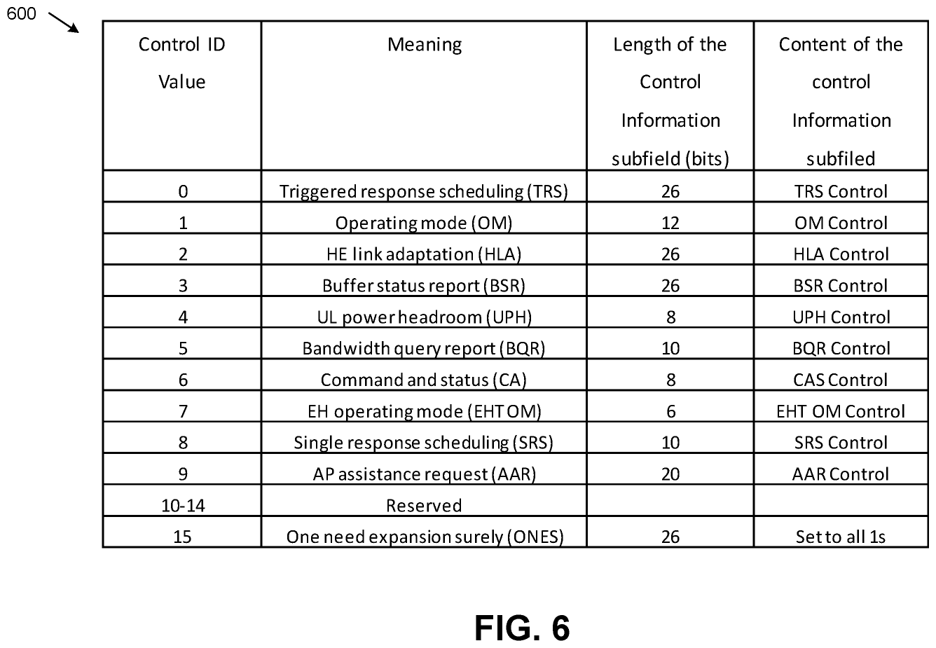

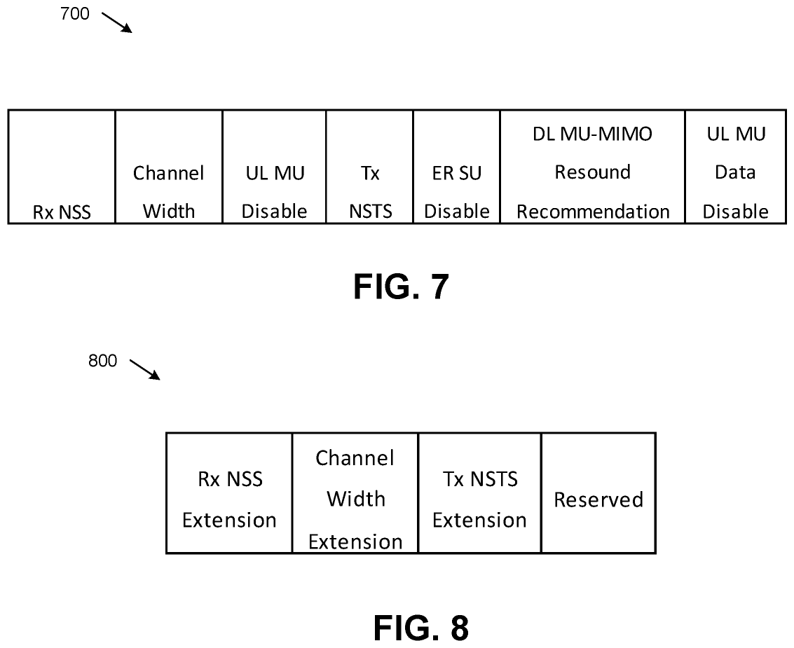

The format of the A-Control (Aggregated Control) subfield of the HE variant HT Control field 400 is shown in FIG. 4, according to some implementations. The A-Control subfield is 30 bits in length. The Control List subfield 402 contains one or more Control subfields. The format of each Control subfield 500 is shown in the illustration of FIG. 5. The Control ID subfield 502 indicates the type of information carried in the Control Information subfield 504. The length of the Control Information subfield 504 may be fixed for each value of the Control ID subfield 502 that is not reserved. The values of the Control ID subfield 502 and the associated length of the Control Information subfield 504 are defined in the table 600 of FIG. 6. For example, an embodiment of the Control Information subfield 504 format for an HE OM control field is illustrated in the table 700 shown in FIG. 7; and an embodiment of the Control Information subfield 504 in an enhanced throughput (EHT) OM control field is illustrated in the table 800 shown in FIG. 8. The HE OM Control field may work as a standalone Control field. The EHT OM Control field may be implemented as an add-on to the HE OM Control field. In another word, the EHT OM Control field and HE OM Control field together may signal an operation mode for EHT STAs. The fields included in FIG. 7 and FIG. 8 may be combined with other fields disclosed herein to indicate the operation parameters to be used under certain condition.

As discussed above, wireless communications may be prone to interference. Interference levels may be asymmetric at the AP side and the non-AP STA side. A non-AP STA may not be able to transmit a response frame due to interference and its associated AP may not have this information. The interference may include in-device interference. In-device transmissions and/or interference may include a transmission from another transmitter or radio communicating on another wireless communication link (e.g., a Bluetooth radio) in the same device. When the non-AP STA may have an in-device interference it may predict some parameters or patterns of the interference. Out-device transmission and/or interference include interference from another device which is not co-located with the STA. A STA may be able to report the interference related information to the AP and the AP may take some actions regarding the upcoming interference.

A STA may be aware of an ongoing or a future wireless transmission nearby. A STA may become aware of ongoing or future wireless transmissions nearby through in-device interference. For example, the STA may have a WiFi radio and a Bluetooth radio. From a higher layer, the STA may receive indications that another STA is going to transmit on the Bluetooth radio and become aware that it may interfere with WiFi radio communications. The ongoing or future wireless transmission may introduce significant interference or interference above a desirable threshold to its own transmission and/or reception. The interfering wireless transmission may be a Wi-Fi transmission, a Bluetooth transmission, a 5G NR-U transmission, a Microwave transmission etc. The interfering wireless transmission may be an in-device transmission or an out-device transmission. With in-device transmission/interference, the STA may be co-located with another transmitter or radio in the same device while the transmission/reception from the co-located radio may introduce in-band interference or out-of-channel/band leakage to the reception of the STA. For example, a Bluetooth radio may be co-located with a Wi-Fi STA. The transmission from the Bluetooth radio may introduce interference to the reception of the Wi-Fi STA. In another example, the STA may be affiliated with a STA MLD co-located in the same device. Another STA affiliated with the STA MLD may perform P2P transmission to its peer STA while the P2P transmission may introduce interference to the reception of the STA. We refer these cases as in-device interference.

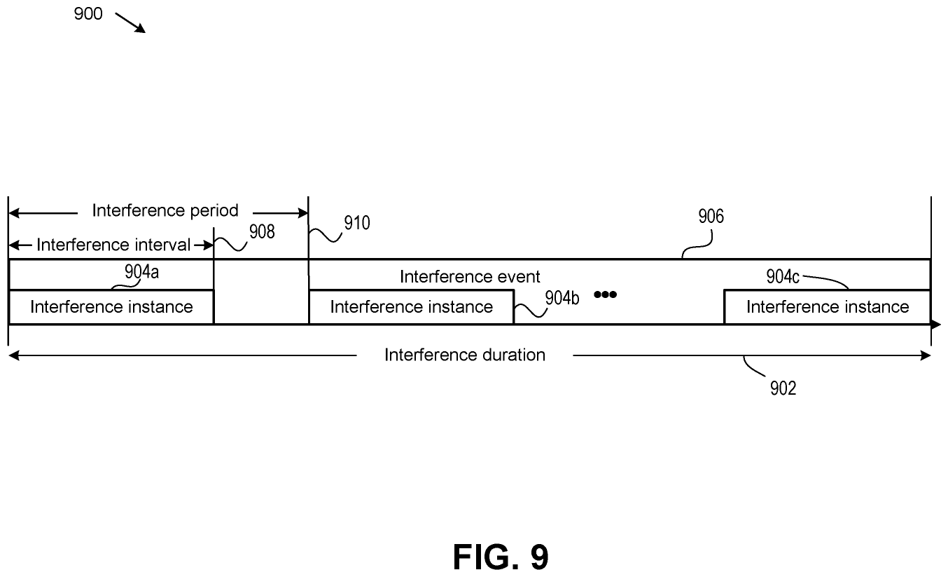

As discussed herein interference may refer to in-device interference, out-device interference, or both. FIG. 9 is a diagram 900 that illustrates example characteristics of an interfering signal at a STA. As shown in the diagram 900, a STA may experience an interference event 906 over an interference duration 902. The interference event 906 may include one or more interference instances, such as interference instances 904a, 904b, 904c. Each interference instance 904a, 904b, 904c may occur within a corresponding interference interval 908, which may occur over an interference period 910.

As used herein, an interference instance 904a, 904b, 904c may refer to a continuous interference signal. The interference interval 908 may refer to the time duration of an interference instance 904a, 904b, 904c. The interference event 906 may comprise one or more interference instances 904a, 904b, 904c, which may occur periodically or aperiodically occur. The interference duration 902 may represent the total time duration of the interference event 906. The interference period 910 may be equal to the average time that the STA expects to elapse between successive interference instance start times.

The STA may report an existing/expected interference event to its associated AP or peer STA over its affected transmission link. When a STA is affiliated with a STA MLD, then another STA affiliated with the same STA MLD may report the interference event to its/their associated AP or a peer STA over its operating link for the STA.

An AP or an AP affiliated with an AP MLD may use the information for link adaptation and/or resource allocation. In another example, the AP or the AP MLD may notice in advance that the STA may not be available and may cease transmission to the STA for a period.

In some embodiments, there may be predefined operation modes with sets of corresponding operation parameters to handle different type of coexistence events or fulfill different system requirements. A STA (e.g., the AP) may select one or more operation mode for communicating with another STA (e.g., a non-AP STA) and signal the selected communication mode to the STA. For example, the AP may select one or more communication modes for communicating with the STA during the interference duration 902. A first operation mode (e.g., Operation mode 0) may indicate a normal transmission or a transmission type that is performed without the use of another operation mode. This mode may be useful for refusal of an AP to change to other operation mode or indicating switching back to normal mode from another operation mode after an interference event, such as the interference event 906.

A second operation mode (e.g., Operation mode 1) may indicate the interference is less significant (e.g., the interference signal power level or duration is below a certain threshold) and a transmission with a reduced modulation and coding scheme (MCS) may be performed. In one example, the interference signal may occur once or less than a predefined number of times for the second operation mode.

A third operation mode (e.g., Operation mode 2) may indicate the interference is more significant (e.g., the interference signal level is above a certain threshold) and no transmission within the interference duration, such as the interference duration 902. In one example, the interference signal may occur once or less than a predefined number of times for the third operation mode.

A fourth operation mode (e.g., Operation mode 3) may indicate the interference is less significant (e.g., the interference signal level is below a certain threshold) and a transmission with reduced MCS may be performed during each interference instance 904a, 904b, 904c within the interference duration 902. In one example, the interference signal may periodically occur for the fourth operation mode.

A fifth operation mode (e.g., Operation mode 4) may indicate the interference is more significant (e.g., the interference signal level is above a certain threshold) and no transmission may be performed during each interference instance 904a, 904b, 904c within the interference duration 902. In one example, the interference signal may periodically occur for the fifth operation mode.

A sixth operation mode (e.g., Operation mode 5) may allow a STA (e.g., an AP) to assign particular clear channel assessment (CCA) level(s) and the maximum allowed transmit power levels to the non-AP STAs which may be affected by an interference event, such as the interference event 906. CCA may be a physical carrier sense that may be used by STAs to listen for RF transmission on a communication medium when the STA is not transmitting or receiving data on the channel. The CCA may be implemented to determine whether the medium is busy before a transmission.

A seventh operation mode (e.g., Operation mode 6) may allow a STA (e.g., an AP) to assign particular CCA level(s) and the maximum allowed transmit power levels to the non-AP STAs which are affected by the interference event during each interference instance within an interference duration, such as the interference duration 902.

An eighth operation mode (e.g., Operation mode 7) may allow a STA (e.g., AP) to use the specific MCSs/rates by default or defined in the basic MCS set or defined in a related element to communicate with another STA (e.g., a non-AP STA) which is affected by an interference event, such as the interference event 906. During the interference duration, such as the interference duration 902, the AP/non-AP STA may disable a link adaptation procedure. The link adaptation procedure may provide a mechanism for a STA to adjust the MCS and/or transmit power of a wireless communication link to maximize the throughput of that link.

A nineth operation mode (e.g., Operation mode 8) may allow a STA (e.g., an AP/non-AP STA) to limit a maximum allowed PPDU duration during an interference duration, such as the interference duration 902, so that the PPDU transmitted is within a limited PPDU duration. The PPDU duration may comprise a transmission time of the PPDU, or a portion thereof.

A tenth operation mode (e.g., Operation mode 9) may allow a STA (e.g., an AP/non-AP STA) to perform preemption operation for physical layer protocol data unit (PPDU) transmissions and/or transmit opportunity (TXOP) transmissions during an interference duration, such as the interference duration 902. With preemption operation, a STA with low latency traffic or a high priority traffic may interrupt the existing transmission in the TXOP and insert the low latency traffic or high priority traffic transmission.

An eleventh operation mode (e.g., Operation mode 10) may allow a STA (e.g., an AP/non-AP STA) to transmit on a secondary channel (instead of always including primary channel).

Other modes may allow the a STA (e.g., the AP) to change its Tx power or using certain resource units (or avoid using certain resource units). In some embodiments, a combination of above defined operation modes may be used to define another operation mode.

A STA (e.g., non-AP STA and/or AP STA) or a STA MLD (e.g., non-AP STA MLD and/or AP MLD) which supports interference awareness procedure/signaling may set a subfield/field of a frame that indicates the capabilities of the STA to indicate to other STAs the support of an interference awareness procedure. For example, an Interference Awareness Support subfield/field may be defined in a UHR/UHR+ Capabilities element or another element. The element may be carried in a Beacon frame, Probe Request/Response frame, (Re) Association Request/Response frame, etc. In another example, the element may be carried in another element such as Neighbor Report element, Reduced Neighbor Report element, Multi BSSID element, Multi-Link element, which may be carried in a management frame or an action frame. For example, a STA which supports interference awareness procedure/signaling may set the Interference Awareness Support field/subfield in the Capabilities element it transmits to 1 . . . . A STA may indicate to other STAs the lack of support of the interference awareness procedure by setting the Interference Awareness Support subfield in the Capabilities element it transmits to 0. Other flags or indicators may be used in similar embodiments.

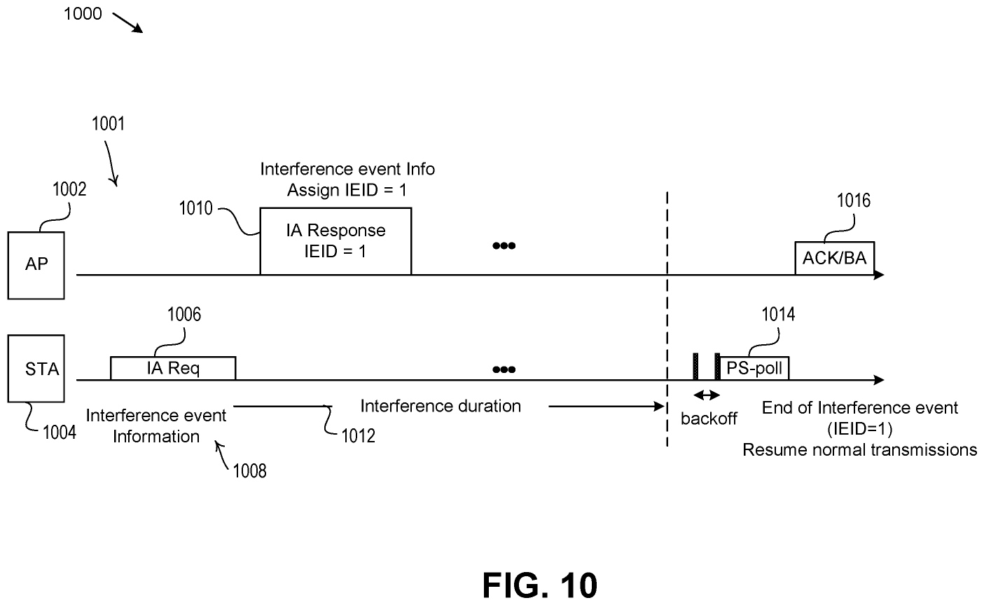

FIG. 10 is a diagram that illustrates signal transmissions for an embodiment of an interference awareness procedure 1000. As shown in FIG. 10, an STA 1004 may be associated with an AP 1002, as shown.

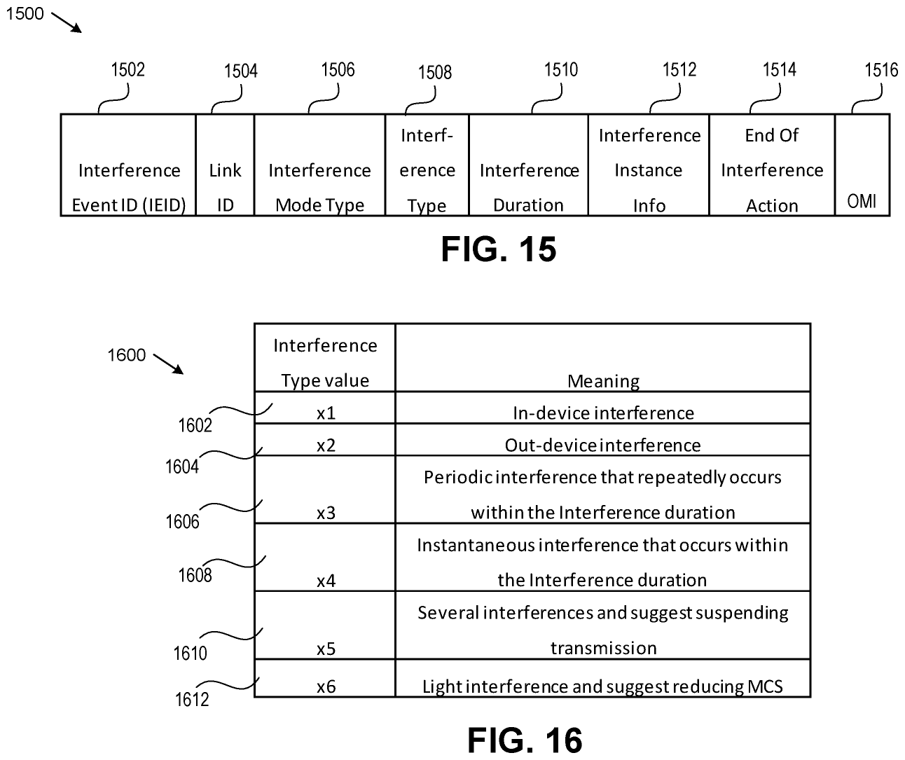

The STA 1004 may detect an expected interference event 1001. The STA 1004 may transmit a frame (e.g., Interference Awareness Request frame 1006) which may carry interference event information 1008 about the interference event to the AP 1002. For example, the interference event information may include one or more portions of the information illustrated in described in FIG. 15. The frame may be a management frame, an Action frame, a control frame or a data frame with a control field in a MAC header.

Based on the interference event information 1008, the AP 1002 may respond with a frame (e.g., Interference Awareness Response frame 1010) to confirm the reception. The responding frame may carry the same information as the interference event information 1008. The AP 1002 may assign an Interference Event ID (e.g., IEID) to the interference event which may broadcast to each of the STAs associated with the AP 1002. The AP 1002 may switch to the operation mode after the reception of the frame 1010 when the AP 1002 may communicate with the STA 1004. If multiple operation modes are defined, the AP 1002 may indicate which operation mode it may switch to in the interference duration 1012. In some embodiments, the AP 1002 may include an Operation Mode Indication (OMI) to indicate its operations during the interference event. The OMI may indicate the operation mode being operated by the AP 1002 in response to the interference event.

After the end of the interference event 1001, the AP 1002 and STA 1004 may follow one or more procedures described herein. For example, the AP 1002 and STA 1004 may follow an example procedure (e.g., Procedure I), as shown in FIG. 10. The STA 1004 may acquire the channel and transmit a frame to the AP 1002 to indicate the end of the interference event and switch back to the normal mode. For example, the STA 1004 may transmit a power save poll (PS-Poll) frame 1014 or other type of frame. The AP 1002 may respond with an acknowledgement frame 1016. The acknowledgement 1016 may be a block acknowledgement. The IEID carried in the initial frame exchanges (e.g., interference awareness (IA) Request 1006/Response 1010) may be carried in the PS-poll frame 1014 and/or acknowledgement frame 1016.

In another example procedure (e.g., Procedure II), the AP 1002 may acquire the channel and transmit a frame to the STA (or multiple STAs) to indicate the end of the interference event and switch back to the normal mode. The STA may respond with an acknowledgement (e.g., ACK/BA). The IEID carried in the initial frame exchanges (e.g., IA Request 1006/Response 1010) may be carried in one or more of the subsequent frames transmitted by the AP 1002 and/or the STA 1004.

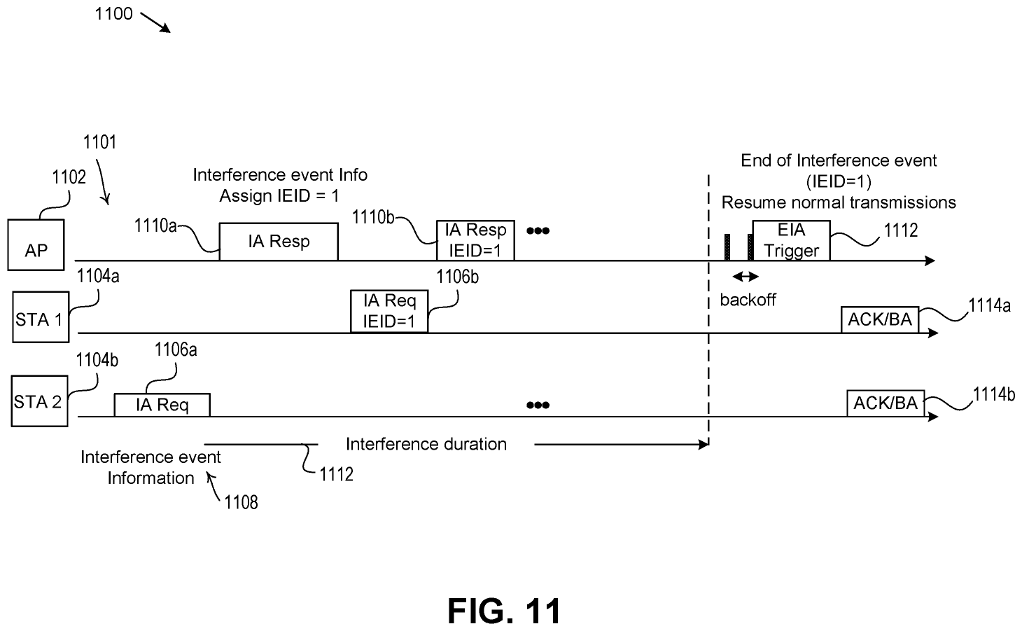

In another embodiment, multiple STAs may be impacted by the same interference event. For example, in a densely deployed system, a STA may have in-device interference while STAs close to it may experience the same interference. FIG. 11 is a diagram that illustrates signal transmissions for another embodiment of an example interference awareness procedure 1100, with multiple STAs.

A non-AP STA, e.g, STA 2 1104b, may expect an interference event 1101. The STA 2 1104b may transmit a frame (e.g., Interference Awareness Request frame, or IA Request frame 1106a) which may carry information 1108 about the interference event to the AP 1102. If the STA 2 1104b does not notice any existing IEID related to the interference event 1101 it reports, the STA 2 1104b may carry a special IEID in the frame to indicate that it may be a new interference event or it may not know the IEID. The frame 1106a may be a management frame, an Action frame, a control frame, or a data frame with a Control field in the MAC header.

Based on the interference event information 1108, the AP 1102 may respond with a frame (e.g., Interference Awareness Response frame, or IA Response frame 1110a) to confirm the reception. In some embodiments, the AP 1102 may set the Receive Address field of the frame 1110a to a broadcast address and thus the frame is a broadcast frame. The responding frame 1110a may carry the interference event information 1108. The AP 1102 may assign an Interference Event ID (IEID) to the interference event 1101 and may broadcast them to each of the STAs (e.g., STA1 1104a, STA2 1104b) associated with the AP 1102. The AP 1102 may switch to the operation mode after the reception of the frame 1106a when the AP 1102 may communicate with the STA 2 1104b. If multiple operation modes are defined, the AP 1102 may indicate which operation mode it may switch to in the interference duration 1112. In some implementations, the AP 1102 may include an OMI to indicate its operations during the interference event 1101.

On reception of the IA Response frame 1110a from the AP 1102, another STA (e.g., STA 1 1104a) may notice that it may experience the same interference event as identified by the IEID (e.g., interference period, interference duration, interference interval are the same or similar enough). The other STA (e.g., STA 1 1104a) may transmit an IA Request frame 1106b to the AP 1102. In some embodiments, the STA (e.g., STA 1 1104a) may transmit a short version of the IA Request frame 1106a which may carry the IEID and/or limited or no other information 1108 about the interference event 1101. In some embodiments, the STA (e.g., STA 1 1104a) may transmit a frame 1106b which may carry the IEID and limited information about the interference event in the MAC frame body or MAC header.

The AP 1102 may respond with an IA Response frame 1110b or a short version of the IA Response frame 1110a which may carry the IEID and limited/no other information about the interference event 1101. In some embodiments, the AP 1102 may transmit a frame 1110b which may carry the IEID and limited information about the interference event 1101 in the MAC frame body or MAC header. In some embodiments, the AP 1101 may include the IMI to indicate its operations during the interference event.

In some embodiments, if the interference event 1101 lasts longer than a Beacon Interval, the AP 1102 may include interference event information 1108 and/or the IEID in the Beacon frame. In this way, non-AP STAs (e.g., STA 1 1104a and/or STA 2 1104b) may know the existing interference event 1101 and be able to indicate to the AP1102 that it may be an affected STA by the interference event 1101.

After the end of the interference event 1101, the AP 1102 may transmit a frame (e.g., an End of Interference Awareness Trigger frame 1112 or other type frame) to each of the STAs (e.g., STA 1 1104a and STA 2 1104b) which are affected by the interference event 1101. The AP 1102 may indicate the end of the interference event 1101 and the IEID may be freed for future use. The frame 1112 may or may not solicit response transmission from the non-AP STAs. In the case the frame solicits response frames, the non-AP STAs may transmit a response frame (e.g., ACK frames 1114a, 1114b, which may be a BA frame, or other type of frames).

In an additional or alternative embodiment, the AP 1102 may expect more than one STA may be impacted by the interference. The AP 1102 may switch to an operation mode to communicate with each of its associated STAs after it receives the initial IA Req 1106 from STA 2 1104b. For example, the AP 1102 may switch to Operation mode 5 by broadcasting the assigned CCA levels and maximum allowed transmit power levels to each of the associated STAs. The assigned CCA levels and maximum allowed transmit power levels may be used during the interference event or the interference instances in the interference event. The assigned CCA levels and maximum allowed transmit power levels may be carried in the IA Response frame 1110a or other frames. Here Operation mode 5 is used as an example, but the AP 1102 may switch to other operation modes. In some embodiments, the AP 1102 may include an Operation Mode Indication (OMI) field to announce its operation mode used.

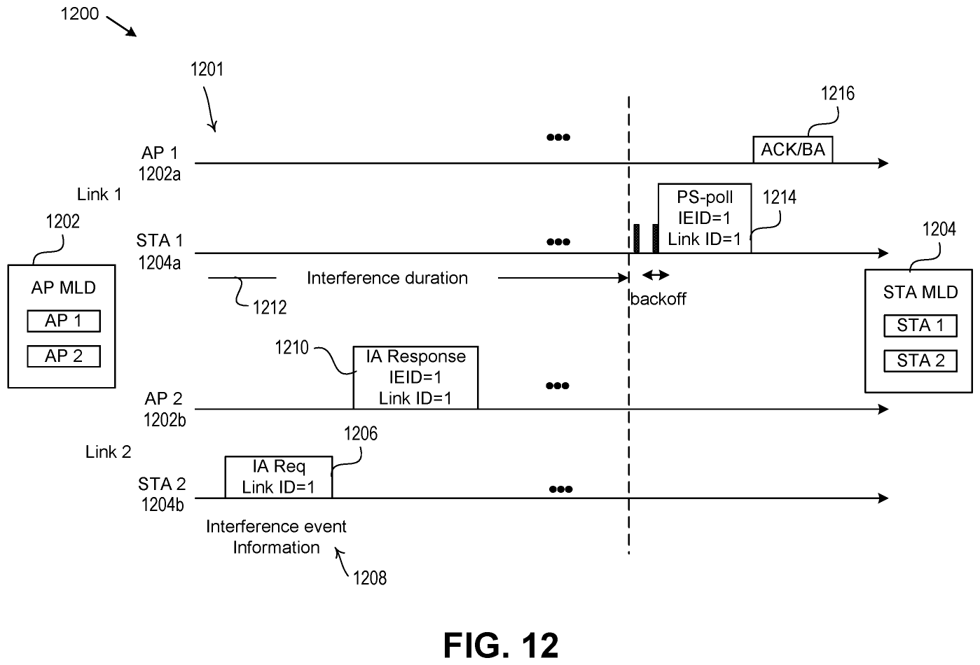

FIG. 12 is a diagram that illustrates signal transmissions for an embodiment of a multi-link interference awareness procedure 1200. As shown in FIG. 12, a STA MLD 1204 is associated with an AP MLD 1202. The STA MLD 1204 has STA 1 1204a operating on Link 1 and STA 2 1204b operating on Link 2. The AP MLD 1202 has AP 1 1202a operating on Link 1 and AP 2 1202b operating on Link 2.

A STA affiliated with a STA MLD 1204 (e.g., STA 1 1204a) may expect an interference event 1201 on a Link (e.g., Link 1). STA 1 1204a may not be able to transmit a frame since CCA is busy. Another STA affiliated with the same STA MLD 1204 (e.g., STA 2 1204b) may transmit a frame (e.g., Interference Awareness Request frame 1206) which may carry information 1208 about the interference event to AP 2 1202b on Link 2. The frame 1206 may carry a Link ID which may indicate the interference event is on Link 2. The frame 1206 may be a management frame, an Action frame, a control frame or a data frame with a Control field in the MAC header.

Based on the interference event information 1208, AP 2 1202b may respond with a frame (e.g., Interference Awareness Response frame 1210) to confirm the reception. The responding frame 1210 may carry the interference event information 1208 and/or a Link ID. The AP 2 1202b may assign an Interference Event ID (IEID) to the interference event which may broadcast to each of the STAs associated with AP 2 1202b. AP 1 1202a may switch to the operation mode after which AP 1 1202a may communicate with the STA 1 1204a. If multiple operation modes are defined, AP 1 1202a may indicate which operation mode it may switch to in the interference duration 1212. In some embodiments, AP2 1202b may include the OMI, as described herein, to indicate its operations by the AP1 1202a on Link 1 during the interference event 1201.

After the end of the interference event 1201, the AP MLD 1202 and STA MLD 1204 may follow one or more example procedures described herein. For example, the AP MLD 1202 and STA MLD 1204 may follow an example procedure (e.g., Procedure I), as shown in FIG. 12. In the example procedure (e.g., Procedure I) shown in FIG. 12, the STA 1 1204a may acquire the channel on Link 1 and transmit a frame to AP 1 1202a to indicate the end of the interference event 1201 and switch back to the normal mode on Link 1. For example, STA 1 1204a may transmit a PS-Poll frame 1214 or other type of frame. AP 1 1202a may respond with an acknowledgement frame 1216 on Link 1. The acknowledgement frame 1216 may include a block acknowledgement frame. The Link ID and/or IEID carried in the initial frame exchanges (e.g., IA Request frame 1206 and/or IA Response frame 1210) may be carried in the PS-poll frame 1214 and/or the acknowledgement frame 1216.

In an additional or alternative procedure (e.g., Procedure II), AP 1 1202a may acquire the channel and transmit a frame to STA 1 1204a (or multiple STAs) to indicate the end of the interference event 1201 and switch back to the normal mode on Link 1. STA 1 1204a may respond with an acknowledgement (e.g., ACK/BA) on Link 1. The Link ID and/or IEID carried in the initial frame exchanges (e.g., IA Request frame 1206 and/or IA Response frame 1210) may be carried in the frame from the AP 1 1202a and/or the acknowledgement.

In an additional or alternative procedure (e.g., Procedure III), STA 2 1204b may acquire the channel on Link 2 and transmit a frame to AP 2 1202b to indicate the end of the interference event 1201 and switch back to the normal mode on Link 1. For example, STA 2 1204b may transmit a PS-Poll frame or other type of frame. AP 2 1202b may respond with an acknowledgement frame on Link 2. The Link ID and/or IEID carried in the initial frame exchanges (e.g., IA Request frame 1206 and/or IA Response frame 1210) may be carried in the frames transmitted between STA 2 1204b and AP 2 1202b.

In an additional or alternative procedure (e.g., Procedure IV), AP 2 1202b may acquire the channel and transmit a frame to STA 2 1204b (or multiple STAs) to indicate the end of the interference event 1201 and switch back to the normal mode on Link 1. STA 2 1202b may respond with an acknowledgement (e.g., ACK/BA) on Link 2. The Link ID and/or IEID carried in the initial frame exchanges (e.g., IA Request frame 1206 and/or IA Response frame 1210) may be carried in the frames transmitted between STA 2 1204b and AP 2 1202b.

Another STA MLD (referred as STA MLD 2 which may have affiliated STA21 on link 1, STA22 on link 2) may experience the same interference event on Link 1. STA22 affiliated with STA MLD 2 may report to the AP 1202b over Link 2 that a STA 21 affiliated with STA MLD 2 on Link 1 may be impacted by the interference event using the methods shown in FIG. 11 and discussed above. In the IA Request frame transmitted by STA22 may use the IEID and Link ID to indicate the interference event and the corresponding link.

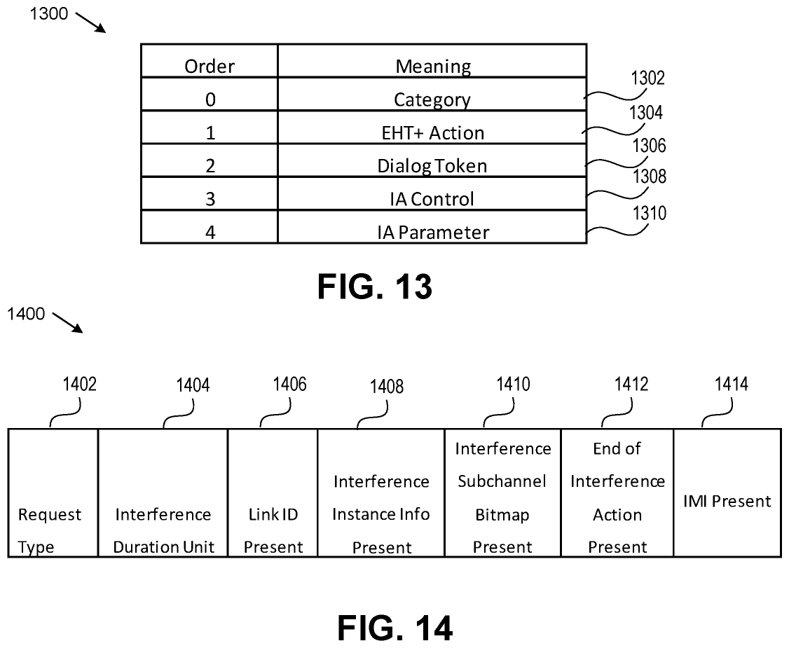

The Interference Awareness Request/Response may be carried by Action frames, Control frames, Management frames, and/or other frames. Action frames may be an example of a frame type that is used (e.g., as shown in FIG. 13) to explain the frame design and/or implementation of frame characteristics. However, other frame formats may be similarly implemented which include a similar design and/or carry similar contents.

The Interference Awareness Request/Response may be carried by an IA Setup frame which may be an Action frame. The IA Setup frame Action field format 1300 is shown in FIG. 13. As shown in FIG. 13, the IA Setup frame Action field format 1300 may include a Category field 1302, an enhanced throughput+ (EHT+) Action field 1304, a Dialog Token field 1306, an IA Control field 1308, and/or an IA Parameter field 1310. The Category field 1302 may show the Action frame category. For example, the Category field 1302 may be set to a specific value that may indicate the Action frame is an EHT+Action frame. The EHT+Action field 1304 may indicate a frame type for the EHT+Action frame. For example, the EHT+Action field 1304 may be set to a specific value may indicate the EHT+Action frame is an IA Setup frame. The Dialog Token field 1306 may be used to identify the IA request/response transaction. The IA Control field 1308 may be defined to include one or more subfields, or the information therein, as provided in FIG. 14. The IA Parameter field 1310 may be defined to include one or more subfields, or the information therein, as provided in FIG. 15.

FIG. 14 is an illustration of an embodiment of an interference awareness (IA) control field 1400. The IA Control field 1400 may include a Request Type subfield 1402, an Interference Duration Unit subfield 1404, a Link ID Present subfield 1406, an Interference Instance Info Present subfield 1408, an Interference Subchannel Bitmap Present subfield 1410, an End of Interference Action Present subfield 1412, and/or OMI Present subfield 1414. The Request Type subfield 1402 may indicate that the frame is an IA Request or an IA Response. The Interference Duration Unit subfield 1404 may indicate the unit of the expected interference duration. For example, the Interference Duration Unit subfield 1404 may be set to 1 may indicate the unit is 256 microseconds (μs). The Interference Duration Unit subfield 1404 may be set to 1 to indicate the unit is 1 time unit (TU) (e.g., 1024 microseconds). The Interference Duration Unit subfield 1404 may be set to 2 to indicate the unit is a Beacon Interval. The Link ID Present subfield 1406 may indicate if the Link ID subfield is present in the IA Parameter field (e.g., such as the IA parameter field 1500 shown in FIG. 15). The Interference Instance Info Present subfield 1408 may indicate if the Interference Instance Information subfield 1512 is present in the IA Parameter field (1500 shown in FIG. 15). The Interference Subchannel Bitmap Present subfield 1410 may indicate if the Interference Subchannel Bitmap subfield is present in the IA Parameter field (e.g., such as the IA parameter field 1500 shown in FIG. 15). The End of Interference Action Present subfield 1412 may indicate if the End of Interference Action subfield is present in the IA Parameter field (e.g., such as the IA parameter field 1500 shown in FIG. 15). The OMI Present subfield 1414 may indicate if the OMI field is present in the IA Parameter field (e.g., such as the IA parameter field 1500 shown in FIG. 15).

FIG. 15 is an illustration of an embodiment of an interference awareness (IA) Parameter field 1500. The IA Parameter field 1500 may identify information associated with an interference event. The IA parameter field 1500 may include an Interference Event ID (IEID) subfield 1502, a Link ID subfield 1502, an Operation Mode Type subfield 1506, an Interference Type subfield 1508, an Interference Duration subfield 1510, an Interference Instance Info subfield 1512, an End of Interference Action subfield 1514, and/or an OMI subfield 1516. The IEID subfield 1502 may be used to identify an interference event. The IEID may be assigned by an AP or AP MLD. One specific IEID value may be used to indicate the STA may not know the IEID. A non-AP STA may include the specific IEID when its reported interference event is not same as any existing interference event broadcasted by its associated AP. A non-AP STA may include the IEID broadcasted by the AP when its reported interference event is the same as the existing interference event identified by the IEID.

The Link ID subfield 1504, if present, may indicate the link on which the interference event may occur. In some embodiments, the IEID may be defined in an MLD level (e.g., different IEIDs may be given to different interference events either on the same link or different links operated by an AP MLD), and thus STA/STA MLDs may notice the link from the IEID. Or the IEID may be defined per link level (e.g., the same IEID may be given to different interference events on different links), and STA/STA MLDs may use both Link ID and IEID to identify the interference event.

The Operation Mode Type subfield 1506 may indicate the operation mode the AP and/or the interference affected STA may switch to during the interference duration or interference intervals. For example, an operation mode (e.g., Operation mode 0) may indicate a normal transmission or a transmission type that is performed without the use of another operation mode. This mode may be useful for refusal of an AP to change to other operation mode or indicating switching back to normal mode from another operation mode after an interference event. Another operation mode (e.g., Operation Mode 1) may indicate the interference is less significant (e.g., the interference signal level is below a certain threshold) and a transmission with reduced MCS may be performed. In one example, the interference signal may occur once or less than a predefined number of times for the Operation Mode 1. Another example operation mode (e.g., Operation Mode 2) may indicate the interference is more significant (e.g., the interference signal level is above a certain threshold) and no transmission within the interference duration. In one example, the interference signal may occur once or less than a predefined number of times for the Operation Mode 2. Another example operation mode (e.g., Operation Mode 3) may indicate the interference is less significant (e.g., the interference signal level is below a certain threshold) and a transmission with reduced MCS may be performed during each interference instance within the interference duration. In one example, the interference signal may occur periodically for the Operation Mode 3. Another example operation mode (e.g., Operation Mode 4) may indicate the interference is more significant (e.g., the interference signal level is above a certain threshold) and no transmission may be performed during each interference instance within the interference duration. In one example, the interference signal may occur periodically during the Operation Mode 4. The thresholds for detecting the interference signal level for each operation mode may be the same or different than the threshold for other operation modes. Another operation mode (e.g., Operation mode 5) may allow a STA (e.g., an AP) to assign particular clear channel assessment (CCA) level(s) and the maximum allowed transmit power levels to the non-AP STAs which may be affected by an interference event. Another operation mode (e.g., Operation mode 6) may allow a STA (e.g., an AP) to assign particular CCA level(s) and the maximum allowed transmit power levels to the non-AP STAs which are affected by the interference event during each interference instance within an interference duration. Another operation mode (e.g., Operation mode 7) may allow a STA (e.g., AP) to use the specific MCSs/rates by default or defined in the basic MCS set or defined in a related element to communicate with another STA (e.g., a non-AP STA) which is affected by an interference event. Another operation mode (e.g., Operation mode 8) may allow a STA (e.g., an AP/non-AP STA) to limit a maximum allowed PPDU duration during an interference duration, so that the PPDU transmitted is within a limited PPDU duration. Another operation mode (e.g., Operation mode 9) may allow a STA (e.g., an AP/non-AP STA) to perform preemption operation for physical layer protocol data unit (PPDU) transmissions and/or transmit opportunity (TXOP) transmissions during an interference duration. Another operation mode (e.g., Operation mode 10) may allow a STA (e.g., an AP/non-AP STA) to transmit on a secondary channel (instead of always including primary channel).

The Interference Type subfield 1508 may indicate the type of expected interference. The example of the encoding of the Interference Type subfield 1508 is shown the table 1600 of FIG. 16. For example, as shown in FIG. 16, the Interference Type subfield 1508 may include a value 1602 that indicates in-device interference, a value 1606 that indicates out-device interference, a value 1606 that indicates periodic interference that may repeatedly occur within an interference duration, a value 1608 that indicates instantaneous interference that may occur within the interference duration, a value 1610 that indicates several interferences and/or suggests suspending transmission, and/or a value 1612 that indicates light interference and/or suggests reducing MCS. One or more of the entries in the table 1600 may be present. In some embodiments, the subfields carried in the Interference Awareness Parameter field/subfield may depend on the value carried in the Interference Type subfield 1508.

Referring again to FIG. 15, the Interference Duration subfield 1510 may indicate the expected interference duration. The Interference Duration subfield 1510 may have N bits and be set to a value from 0 to 2N-1. One specific value (e.g., 0) may indicate no duration information. The Interference Duration subfield 1510 set to a value x may indicate the closest expected interference duration of f(x). f(x) may be a predefined function. For example, f(x)=x; f(x)=2^{x}; f(x)=C2^{x} where C is a predefined value, or a value carried explicitly by a subfield in the IA Parameter field (not shown in the table) etc. The Interference Interval subfield may indicate the time duration of an interference instance or the average time duration of interference instances.

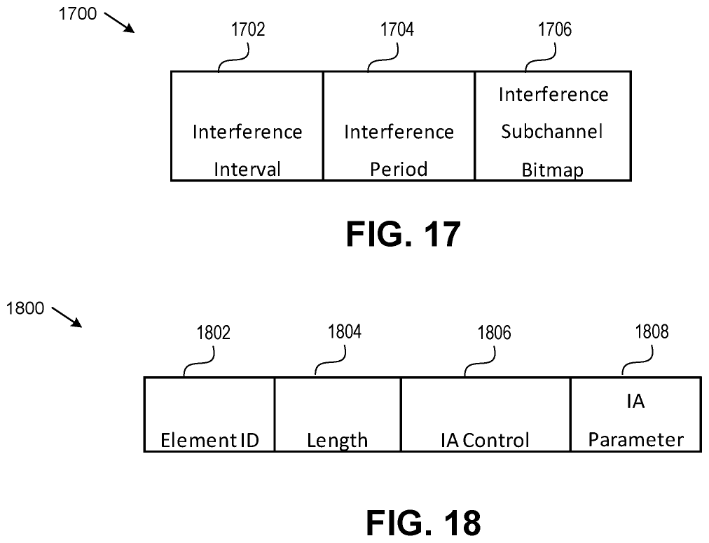

Interference Instance Information subfield 1512 may define information and/or parameters for an interference instance. FIG. 17 is an illustration of an embodiment of an Interference Instance Information subfield 1700, which may define similar information and/or parameters to the Interference Instance Information subfield 1512 shown in FIG. 15. As shown in FIG. 17, the Interference Instance Information subfield 1700 may include an Interference Interval subfield 1702, an Interference Period subfield 1704, and/or an interference Subchannel Bitmap subfield 1706. The Interference Interval subfield 1702 may indicate the time duration of an interference instance and/or the average time duration of interference instances. The Interference Period subfield 1704 may be equal to the average time to elapse between successive interference instance start times. The Interference Subchannel Bitmap subfield 1706 may indicate the subchannels which are impacted by the interference event. One or more bits in the Bitmap may be set to a value (e.g., a value of 1) to indicate the corresponding subchannel is impacted by the interference event.

Referring again to FIG. 15, the End Of Interference Action subfield 1514 may indicate the non-AP STA's action after the end of the expected Interference Duration. For example, the End Of Interference Action subfield 1514 may be set to a value (e.g., a value of 0) to indicate the non-AP STA is expected to send the a frame (e.g., PS-Poll, Automatic Power Save Delivery (APSD) trigger frame, or other type of frame) to the AP to indicate the end of the interference event. The End Of Interference Action subfield 1514 may be set to a value (e.g., a value of 1) to indicate the AP is expected to send the a frame to the non-AP STA(s) to indicate the end of the interference event. The OMI field 1516 is defined and described in more detail herein. For example, the OMI field 1516 may be defined and described to include one or more fields, and/or the information therein, as described with reference to FIG. 21.

Alternatively, or additionally, the above mentioned information may be carried in an Interference Awareness element 1800 shown in FIG. 18. The Interference Awareness element 1800 may include an Element ID field 1802, a Length field 1804, an IA Control field 1806, and/or an IA Parameter field 1808. The IA Control field 1806 may include one or more subfields, and/or information therein, as described with reference to the IA Control field 1400 of FIG. 14. The IA Parameter field 1808 may include one or more subfields, and/or information therein, as described with reference to the IA Parameter field 1500 of FIG. 15. The Element ID field 1802 may carry an identity of the element. The Length field 1804 may indicate the length of the element.

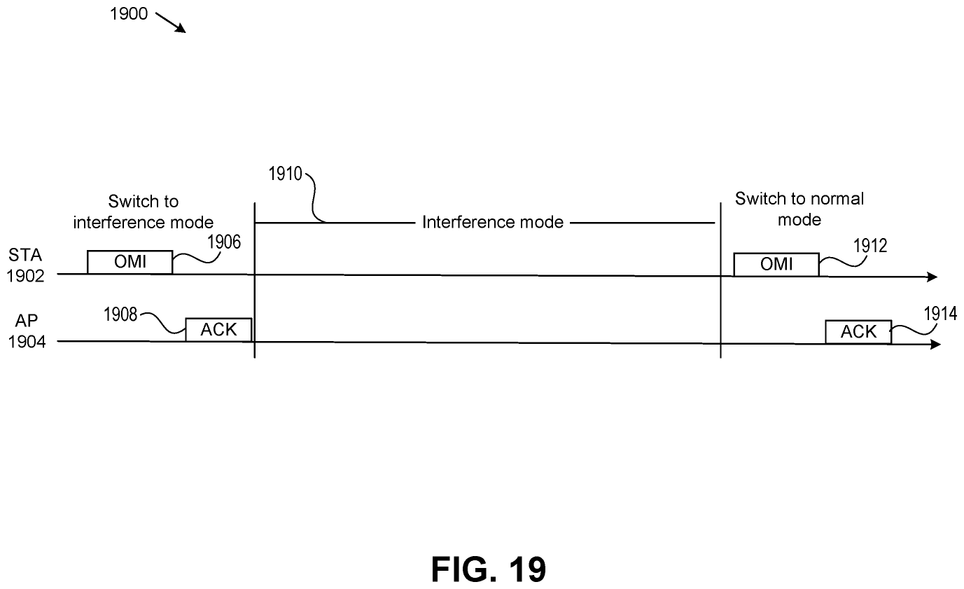

FIG. 19 is a diagram of an example illustration of signal transmissions for another embodiment of an interference awareness procedure 1900, utilizing operational mode changes. In some implementations, the IEID may be carried in an enhanced or modified Operating Mode (OM) Control field in A-Control field in MAC header. If the IEID value carried in the enhanced or modified OM Control field indicates an existing interference event, the receiver (e.g., an AP) may know the transmitter (e.g., a STA) may be an affected STA by the identified interference event. The transmitter may switch to the operation mode corresponding to the interference event until the end of the interference event.

In some embodiments, a subfield (e.g., one or more bits) in the enhanced or modified OM Operation Control field may indicate the transmitting STA may switch to an operation mode. The subfield may be referred as an Interference Subfield. The corresponding transmission/reception limitation of the operation mode may be applied. At the end of the interference event, the STA may transmit another frame and set the field back to indicate the switch to normal mode from the operation mode. The frame carrying the enhanced or modified OM Control field in the MAC header may be referred to as an Operating Mode Indication (OMI).

An exemplary procedure 1900 is shown in FIG. 19. An STA 1902 and an AP 1904 may announce their support of an Operating Mode Indication (OMI) in the Capabilities element during an association procedure. The AP 1904 may announce it through Beacon transmissions, additionally or alternatively. The STA 1902 may expect some interference, and the STA 1902 may suggest switching to the operation mode 1910 (e.g., one or more operation modes may be defined and known by both transmitter and receiver) in an OMI 1906 (e.g., by setting the Interference Subfield in the OM Operation Control field of the OMI 1906 to true). In one example, the enhanced or modified OM Control field is carried in the MAC header of a frame (e.g., a data frame, a management frame or a control frame). The Duration field carried in the MAC header of the frame may be used to indicate the time duration of the operation mode.

On reception of the OMI 1906, the AP 1904 may respond with an ACK frame 1908 to indicate the reception of the OMI 1906 and ready to switch to the operation mode 1910. In some embodiments, the AP 1904 may respond with a frame including an operation mode indication (OMI) field to indicate the actions/operations the AP 1904 may utilize during the upcoming interference event and/or after the frame exchanges.

After certain time duration, the STA 1902 may notice the interference event may be ended (e.g., through higher layer signaling or a sensing result, such as a sensing result indicating a channel is idle) and the STA 1902 may suggest suspending the operation mode by sending an OMI 1912 with an Interference Subfield as false. The OMI 1912 may comprise an OMI request or an OMI requestion, for example. On reception of the OMI 1912, the AP 1904 may respond with an ACK frame 1914 to indicate the reception of the OMI 1912 and that the AP 1904 is ready to suspend the operation mode 1910. In some embodiments, the AP 1904 may respond with a frame with an OMI field to indicate the actions/operations the AP 1904 may utilize after the frame exchanges.

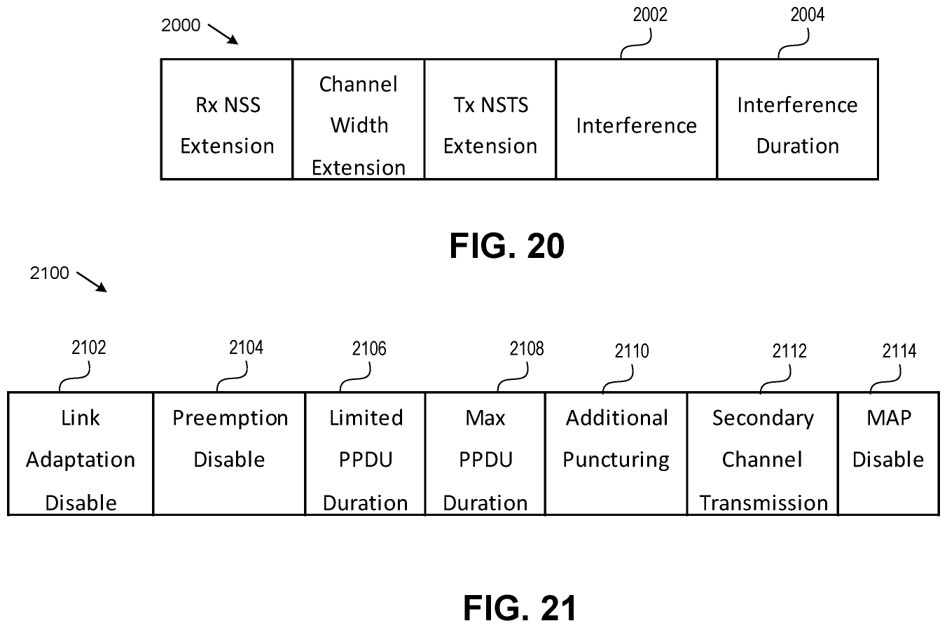

An exemplary design of the OM Control field 2000 with interference related information is shown in FIG. 20. Comparing to the HE OM Control field 700 shown in FIG. 7, the following subfields may be added as an enhanced OM Control field 2000: an Rx NSS Extension subfield, an Channel Width Extension subfield, an NSTS Extension subfield, an Interference subfield 2002 and an Interference Duration subfield 2004. The Rx NSS Extension subfield may be implemented with Rx NSS field in HE OM Control field to indicate the number of receive spatial stream allowed in the operation mode. The Channel Width Extension subfield may be implemented with Channel Width field in HE OM Control field to indicate the number of operation channel width allowed in the operation mode. The Tx NSTS Extension subfield may be implemented with Tx NSTS field in HE OM Control field to indicate the number of transmit spatial time stream allowed in the operation mode. The Interference subfield 2002 may indicate if the STA may expect an upcoming interference event. The Interference Duration subfield 2004 may indicate the quantized duration of the upcoming interference. When the Interference Duration subfield 2004 is set to a value (e.g., a value of 0), it may indicate that the STA does not know the interference duration. The enhanced OM Control field may be implemented as a standalone Control field or it may work with the HE OM Control field shown in FIG. 7 together.

An Operation Mode Indication (OMI) field may be defined to indicate what kind of transmission is limited or suggested. An example of an OMI field 2100 is shown in FIG. 21. As shown in FIG. 21, a Link Adaptation Disable subfield 2102 may indicate if the link adaptation is allowed or suspended. A Preemption Disable subfield 2104 may indicate if the preemption operation is allowed or suspended. In an example, one or more Preemption Disable subfields 2104 may indicate if the DL/UL preemption operation is allowed or suspended. For example, Downlink (DL) Preemption Disable and/or Uplink (UL) Preemption Disable subfields may be defined in the OMI field 2100 to indicate if the DL/UL preemption operation is allowed or suspended. A Limited PPDU Duration subfield 2106 may indicate if the PPDU duration has limitation. A Max PPDU Duration subfield 2108 may indicate the maximum allowed PPDU duration. A specific value (e.g., value 0) of the Max PPDU Duration subfield 2108 may indicate the PPDU duration has no limitation. An Additional Puncturing subfield 2110 may be set to true to indicate additional subchannels besides the disabled subchannel(s) indicated in the Beacon frame may need to be punctured. In some embodiments, a punctured subchannel bitmap may be included in the OMI to indicate which subchannel(s) may be punctured. A Secondary Channel Transmission subfield 2112 may indicate that transmissions may be performed using a secondary channel. The Secondary Channel Transmission may refer to the transmissions not using primary channel (e.g., transmissions not using the primary 20 MHz channel, or primary 80 MHz channel). In some embodiments, the Secondary Channel Transmission subfield 2112 may be a bitmap which indicates which secondary channel(s) may be used for transmissions. For example, to support up to 320 MHz channel width, the bitmap may be 4 bit long. Each bit in the bitmap may indicate an 80 MHz channel. The bit is set to 1 may indicate the corresponding 80 MHz channel will be utilized and STAs may monitor that 80 MHz channel. A MAP Disable subfield 2114 may indicate the multi-AP transmission is allowed or suspended.

The OMI field may be carried in an A-Control field or another field in the MAC header or a MAC frame (e.g., ACK frame or block ACK frame) or an element (e.g., a target wake time (TWT) element). STAs (APs and/or non-AP STAs) which support operation mode indication may set the OMI Support field in a Capabilities element to 1. An OMI procedure may be used between an OMI initiator and an OMI responder. A STA that initially transmits a frame with OMI may be the OMI initiator and the STA that receives a frame with OMI and responds may be an OMI responder. Both AP and non-AP STA could be the OMI initiator and/or the OMI responder.

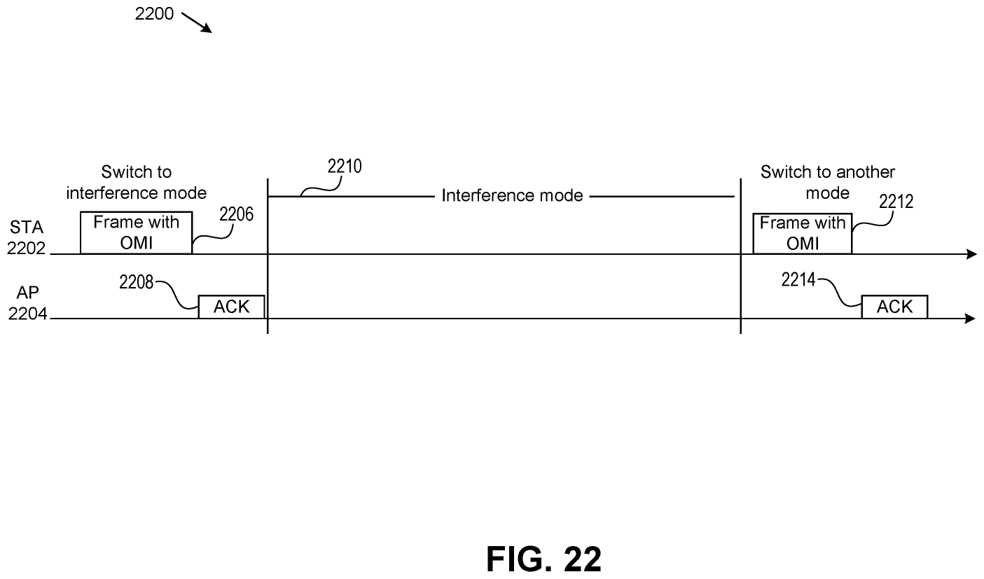

FIG. 22 is a diagram including an example illustration of an embodiment of an interference awareness procedure 2200, using an OMI transmission to switch to operation mode. A STA 2202 and an AP 2204 may announce their support of OMI in the Capabilities element during association procedure. The AP 2204 may announce the support of OMI through Beacon transmissions, additionally or alternatively.

The STA 2202 may expect some interference (e.g., from higher layer signaling), and the STA 2202 may transmit a suggestion to switch to an operation mode 2210, such as by transmission of a frame 2206. The frame 2206 may include an OMI field. The frame 2206 may include an OMI request or requestion, for example. The requestion may comprise a suggestion of an operation mode 2210, for example. The frame 2206 may suggest some operation mode related operation to its associated AP 2204. For example, the STA 2202 may suggest the AP 2204 disabling the link adaptation algorithm by setting Link Adaptation Disabling subfield in the OMI field to true. On reception of the frame 2206 comprising the OMI or OMI requestion, the AP 2204 may perform one or more actions. For example, on reception of the frame 2206, the AP 2204 may transmit an acknowledgement frame 2208 to indicate the reception of the frame 2206 comprising the OMI. The AP 2204 may follow the suggestion by the STA 2202 in the frame 2206 and disable the link adaptation operation. Additionally, or alternatively, the AP 2204 may transmit a frame with OMI to confirm, reject, or modify the STA 2202's suggestion. The AP may make the decision based on the network condition. Both the AP 2204 and the STA 2202 may follow the mode 2210 transmitted by the AP 2204.

After a certain time duration, the STA 2202 may notice the interference event may be ended (e.g., from higher-layer signaling) and the STA 2202 may suggest another operation mode related operation to its associated AP 2204. For example, the STA 2202 may transmit a frame 2212. The frame 2212 may include an OMI field. The frame 2212 may include an OMI request or requestion, for example. The requestion may comprise a suggestion of an operation mode, for example. The frame 2212 may suggest some operation mode related operation to its associated AP 2204. For example, the frame 2212 may suggest the AP 2204 enable the link adaptation algorithm by setting Link Adaptation Disabling subfield in the OMI field to false. On reception of the frame 2212 comprising the OMI or OMI requestion, the AP 2204 may transmit an acknowledgement frame 2214 to indicate the reception of the OMI. The AP 2204 may follow the suggestion by the STA 2202 and enable the link adaptation operation. Additionally, or alternatively, the AP 2204 may transmit a frame with OMI to confirm or reject or modify the STA 2202's suggestion. Both the AP 2204 and the STA 2202 may follow the mode transmitted by the AP 2204. In the example shown in FIG. 22, a non-AP STA is the OMI initiator, however, the AP and/or the non-AP STA could be the OMI initiator.

In some instances of multi-AP (MAP) communications, it may be beneficial to have the non-AP STAs report the interference received from different sources. The sources may include interference from non-associated APs and/or in-device coexistence interference from other types of traffic. Interference patterns may be predictable or non-predictable, periodic or aperiodic. Accordingly, it may be beneficial to provide feedback reports for such interference, such as in sounding feedback.

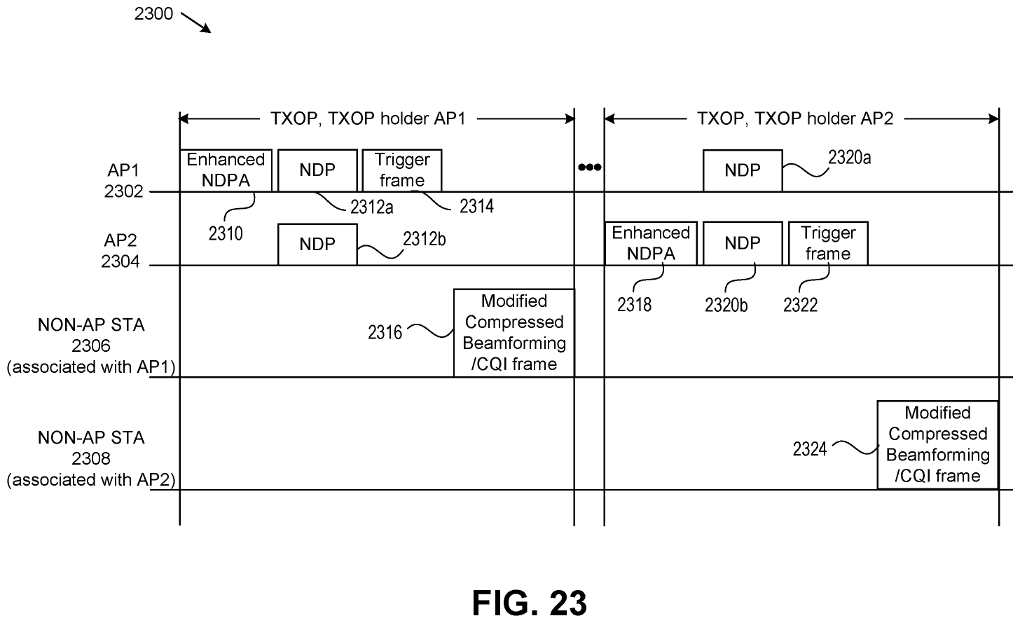

In some embodiments, the AP may request interference reports from one or more of its associated STAs through an enhanced sounding procedure. The interference report may be fed back together with the compressed beamforming or fed back individually from the solicited STA(s). The exemplary procedure 2300 of Interference Report carried in the Compressed Beamforming Report/CQI report is illustrated in FIG. 23. In the illustrated example, AP1 2302 may transmit an Enhanced NDP Announcement frame 2310 to solicit the NDP transmissions 2312a, 2312b from multiple APs (e.g., AP1 2302 and AP2 2304) a Short Interframe Space (SIFS) after the Enhanced NDPA 2310 transmission. A trigger frame 2314 may be sent from AP1 2302 that transmitted the enhanced NDPA 2310 a SIFS after NDP transmission 2312a. The solicited beamformee indicated in the enhanced NDP Announcement frame 2310 (e.g. non-AP STA 2306) may transmit a Modified Compressed Beamformee/CQI frame 2316. For example, the solicited beamformee may be the non-AP STA 2306 that is associated with the AP1 2302. The Modified Compressed Beamformee/CQI frame 2316 may carry the interference reports measured via NDPs transmitted from AP1 2302 and AP2 2304. Each of the frames may be transmitted during a TXOP initiated by the AP1 2302.

As shown in FIG. 23, AP2 2304 may transmit an Enhanced NDP Announcement frame 2318 to solicit the NDP transmissions 2320a, 2320b from multiple APs (e.g., AP1 2302 and AP2 2304) a SIFS after the Enhanced NDPA 2318 transmission. A trigger frame 2322 may be sent from AP2 2304 that transmitted the enhanced NDPA 2318 a SIFS after NDP transmission 2312b. The solicited beamformee indicated in the enhanced NDP Announcement frame 2318 (e.g. non-AP STA 2308) may transmit a Modified Compressed Beamformee/CQI frame 2324. For example, the solicited beamformee may be the non-AP STA 2308 that is associated with the AP2 2304. The Modified Compressed Beamformee/CQI frame 2324 may carry the interference reports measured via NDPs transmitted from AP1 2302 and AP2 2304. Each of the frames may be transmitted during a TXOP initiated by the AP2 2304.

Different situations may provoke a variant of sounding procedure which is different from the one shown in FIG. 23. For example, in some embodiments, if the AP that transmits the Enhanced NDPA frame solicits the NDP transmission from itself, then no Trigger frame may be present if there is one beamformee is solicited in the Enhanced NDPA frame. If multiple beamformees are present, a Trigger frame may be implemented. In other embodiments, if the AP that transmits the Enhanced NDPA frame solicits the NDP transmission from another STA (e.g., AP2 or other non-AP STA), then a Trigger frame may be present no matter how many beamformees are solicited in the Enhanced NDPA frame. The beamformee may follow instructions indicated in the Enhanced NDPA frame to include the feedback information carried in the Modified Compressed Beamforming/CQI frame.

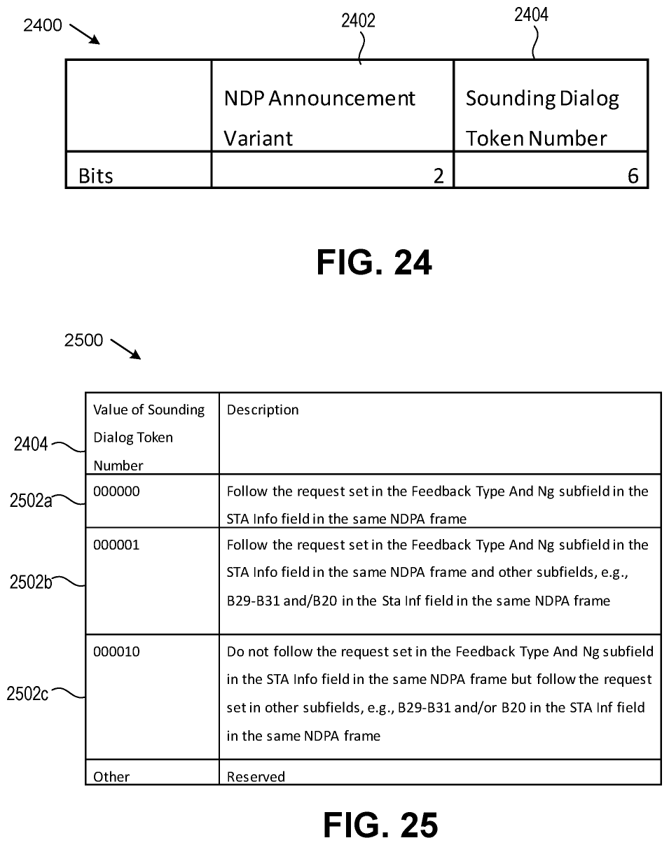

In some embodiments, the feedback request type may be indicated in a subfield of an NDP Announcement frame or an EHT NDP Announcement frame. For example, the feedback request type may be indicated in a number of bits (e.g., six bits) in a Sounding Dialog Token Number subfield 2404 in a Sounding Dialog Token field of the NDP Announcement frame or Enhanced NDPA frame, as indicated FIG. 24. The NDP Announcement frame may include an NDP Announcement Variant field 2402. In this example, if one or more bits (e.g., two bits) of the NDP Announcement Variant field 2402 in the NDP Announcement frame is set to a value (e.g., a value of 3), the value may indicate that the NDP Announcement frame is an EHT NDP Announcement frame.

The EHT NDP Announcement frame may include a Sounding Dialog Token field that comprises a Sounding Dialog Token Number subfield 2404. The AP may set a specified value (e.g., one of values 2502a-2502c of the table 2500 shown in FIG. 25) in the Sounding Dialog Token Number subfield 2404 in the Sounding Dialog Token field to further indicate if any feedback type is being requested from the beamformee or not. FIG. 25 includes a table 2500 depicting an exemplary Sounding NDP Announcement Variant field encoding within the Sounding Dialog Token Number subfield 2404 when the NDP Announcement frame is set to 3. As shown in FIG. 25, the Sounding Dialog Token Number subfield 2404 may be set to a value 2502a (e.g., 000000) to indicate to follow a request set in certain subfields of the NDPA frame. For example, the value 2502a (e.g., 000000) may indicate to follow the request set in a Feedback Type And Ng subfield in the STA Info field in the NDPA frame. The Sounding Dialog Token Number subfield 2404 may be set to a value 2502b (e.g., 000001) to indicate to follow the request set in other subfields of the NDPA frame. For example, the value 2502b (e.g., 000001) may indicate to follow the request set in a Feedback Type And Ng subfield in the STA Info field in the NDPA frame and other subfields (e.g., B29-B31 and/or B20) in the STA Info field in the same NDPA frame. The Sounding Dialog Token Number subfield 2404 may be set to a value 2502c (e.g., 000010) to indicate to not follow the request set in one or more subfields of the NDPA frame, but to follow the request set in at least one other subfield of the NDPA frame. For example, the value 2502c (e.g., 000010) may indicate not to follow the request set in a Feedback Type And Ng subfield in the STA Info field in the NDPA frame, but to follow the request set in other subfields (e.g., B29-B31 and/or B20) in the STA Info field in the same NDPA frame.

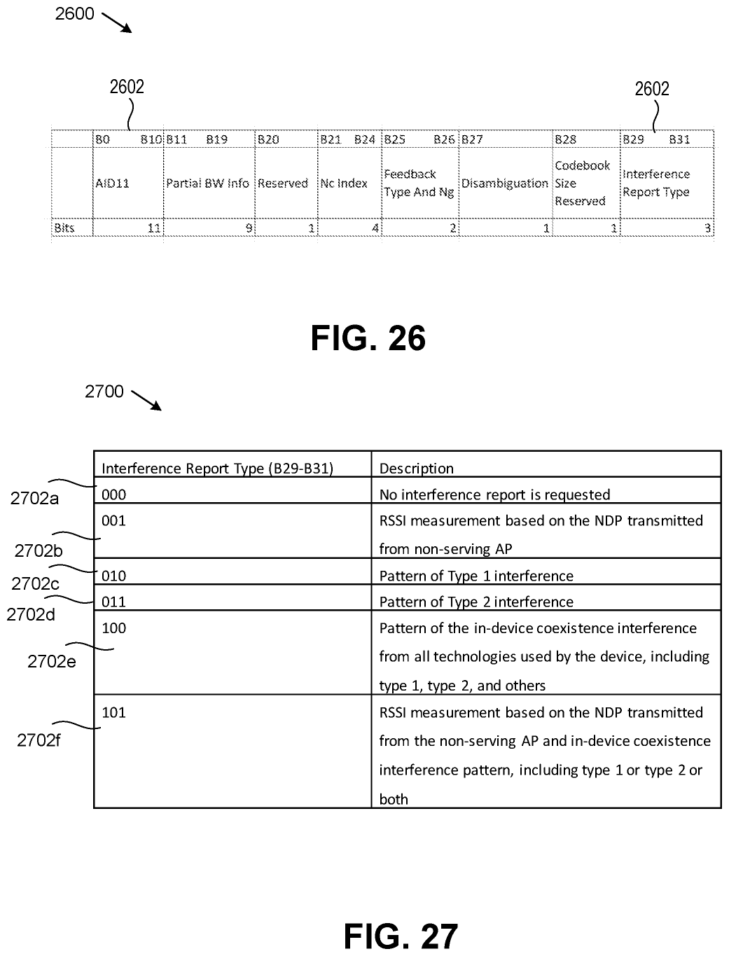

In some embodiments, an interference report request may be carried in the STA Info field in the Enhanced EHT NDPA frame. FIG. 26 includes a table 2600 that depicts an exemplary enhanced STA Info field format in an Enhanced EHT NDPA frame. In this example, if one or more bits (e.g., two bits) of the NDP Announcement Variant field 2402 in the NDP Announcement frame is set to a value (e.g., a value of 3), the value may indicate that the NDP Announcement frame is an EHT NDPA frame. The Enhanced EHT NDPA frame may include an Interference Report Type subfield 2602. In this example, the Interference Report Type subfield 2602 carried in B29-B31 may include a number of bits (e.g., 3 bits) that indicate that the interference report type requested for the STA whose ID is indicated in an association identifier (AID) subfield 2604 of the an EHT NDPA frame that identifies the AID of the STA.

One example of the Interference Report Type subfield 2602 encoding is illustrated in the table 2700 in FIG. 27. There may be multiple types of in-device coexistence interference source. For example, a first type of in-device coexistence interference source (e.g., Type 1) may be from the devices sharing the same RF chain or the operating band. Another type of in-device coexistence interference source (e.g., Type 2) may be from devices which may not share the same RF chain or the operating band, but is operating on the band adjacent to the BSS operating band.

As shown in FIG. 27, the Interference Report Type subfield 2602 may be set to a value 2702a (e.g., 000) to indicate that no interference report is requested. The Interference Report Type subfield 2602 may be set to a value 2702b (e.g., 001) to indicate an RSSI measurement based on the NDP transmitted from non-serving AP. The Interference Report Type subfield 2602 may be set to a value 2702c (e.g., 010) to indicate a pattern of Type 1 interference. The Interference Report Type subfield 2602 may be set to a value 2702d (e.g., 011) to indicate a pattern of Type 2 interference. The Interference Report Type subfield 2602 may be set to a value 2702e (e.g., 100) to indicate a pattern of in-device coexistence interference from all technologies used by the device, including Type 1 interference, Type 2 interference, and/or others. The Interference Report Type subfield 2602 may be set to a value 2702f (e.g., 101) to indicate RSSI measurement based on the NDP transmitted from the non-serving AP and in-device coexistence interference pattern, including Type 1 interference, Type 2 interference, or both.

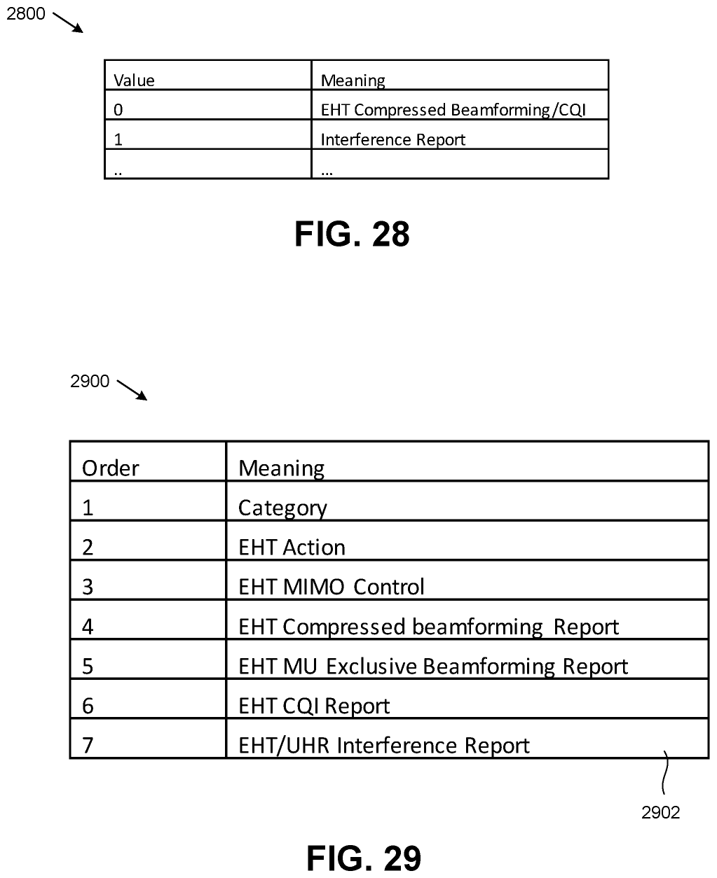

In some embodiments, Interference Reports may be included as a frame in an Enhanced EHT or UHR Action field. The example of Modified EHT Action field values is given in FIG. 28. When the EHT Action field is set to a value (e.g., 1), it may imply that an Interference Report is included. Alternatively, the presence of the report can be indicated as a separate Action field, e.g., the UHR Action field.

In other embodiments, the EHT/UHR Interference Report may be included in the Enhanced EHT Compressed beamforming/CQI frame. The Modified EHT Compressed Beamforming/CQI frame Action field may include the existing fields such as Category field, EHT Action field, EHT MIMO Control field, EHT Compressed beamforming Report field, EHT MU Exclusive Beamforming Report field, EHT CQI Report field. Moreover, the Modified EHT Compressed Beamforming/CQI frame Action field may include EHT/UHR Interference Report 2902 as indicated in the table of FIG. 29.

The EHT/UHR Interference Report field carrying the interference report may include one or more of an RSSI measurement, a pattern of Type 1 interference, and/or a pattern of Type 2 interference. The RSSI measurement based on the received NDP from non-associated APs, e.g., the collaborating beamformer that transmits NDP but does not transmit NDPA. The pattern of Type 1 interference, i.e., the in-device coexistence interference coming from another technology which may share the same RF chain or the operating band, e.g., Bluetooth. The pattern may include traffic appearance pattern of this technology. The traffic may include incoming traffic and/or outcoming traffic. The incoming traffic includes the packet(s) which will be received by the STA. The outcoming traffic includes the traffic that the STA will transmit the packet. Therefore, the pattern may include the incoming traffic pattern and/or outcoming traffic pattern, e.g., the incoming/outcoming traffic periodicity, the incoming/outcoming traffic ON/OFF duration, the starting time of the incoming/outcoming traffic. The maximum or minimum transmit power may be used for this type of traffic transmission, in various embodiments. The pattern of Type 2 interference, i.e., the in-device coexistence interference coming from another technology which may not share the same RF chain, but the operating band is adjacent to the BSS operating band, e.g., LTE/5G-NR. This type of traffic may only cause the interference when it occupies the channel adjacent to the ISM band. Similarly, the traffic may include the incoming traffic and outcoming traffic. The traffic pattern may include the incoming/outcoming traffic periodicity, the incoming/outcoming traffic ON/OFF duration, the starting time of the incoming/outcoming traffic. The maximum or minimum transmit power may be used for this type of traffic transmission. This type of traffic, e.g., LTE/5G-NR traffic, may not be periodic all of the time, but may be variously periodic and/or aperiodic, and may be non-predictable in some instances. The gNB/eNB may signal the device the assigned RBs for the UL/DL transmission. In such implementations, the device (e.g., non-AP STA) may feedback this non-predictable in-device coexistence interference information. This information may include the starting time of the traffic and the duration of the traffic, transmit power used for this traffic, the BW occupied by this traffic, etc. In some embodiments, CSI reports and beamforming reports/CQI may be interchangeable.

Although the solutions described herein consider 802.11 specific protocols, it is understood that the solutions described herein are not restricted to this scenario and are applicable to other wireless systems as well. Although SIFS is used to indicate various inter frame spacing in the examples of the designs and procedures, all other inter frame spacing such as RIFS, AIFS, DIFS or other agreed time interval could be applied in the same solutions. Although a sub-7 GHZ link/band is used to refer to a link in MLO system where the control/management frames may be transmitted for mmW link/band, in other embodiments, a lower frequency link/band may be utilized.

In a first aspect, the present disclosure is directed to a method, comprising: detecting, by a wireless transmit/receive unit (WTRU) of a first device, an interference event comprising a transmission that will interfere or is interfering with a communication session of the WTRU with a second device; transmitting, by the WTRU to the second device, an identification of the interference event; receiving, by the WTRU from the second device, a selection of an operation mode of a plurality of modes, transmitted responsive to receipt of the identification of the interference event; and continuing the communication session, by the WTRU with the second device, utilizing the selected operation mode.

In some implementations, the interference event comprises a transmission generated by a second WTRU of the first device. In some implementations, the interference event comprises a transmission generated by another device.

In some implementations, detecting the interference event further comprises detecting, prior to the interference event, that the interfering transmission will occur. In some implementations, continuing the communication session utilizing the selected operation mode further comprises reducing, by the first device, a modulation and coding scheme rate for transmissions of the communication session. In some implementations, continuing the communication session utilizing the selected operation mode further comprises delaying, by the first device, one or more transmissions for an identified interference duration. In some implementations, continuing the communication session utilizing the selected operation mode further comprises utilizing, by the first device, a clear channel assessment (CCA) level or maximum allowed transmit power level indicated by the second device for transmissions of the communication session. In some implementations, continuing the communication session utilizing the selected operation mode further comprises utilizing, by the first device, a maximum allowed physical layer protocol data unit (PPDU) indicated by the second device for transmissions of the communication session. In some implementations, continuing the communication session utilizing the selected operation mode further comprises utilizing, by the first device, a preemption operation for physical layer protocol data unit (PPDU) or transmission opportunity (TXOP) transmissions during an identified interference duration. In some implementations, continuing the communication session utilizing the selected operation mode further comprises utilizing, by the first device, a secondary communication channel.

In some implementations, the selected operation mode is selected based on a signal strength of the interference event. In some implementations, the method includes transmitting, by the first device to the second device, an identification of an end of the interference event. In some implementations, the transmission that will interfere or is interfering with a communication session of the WTRU with a second device is on a first communication channel; and the method includes transmitting the identification using a second communication channel.

In another aspect, the present disclosure is directed to a device, comprising a wireless transmit/receive unit (WTRU), configured to perform one or more of the above-discussed embodiments. In another aspect, the present disclosure is directed to a system, comprising a transmitter, a receiver, and one or more processors configured to perform one or more of the above-discussed embodiments. In another aspect, the present disclosure is directed to a network element configured to perform at least part of one or more of the above-discussed embodiments. In another aspect, the present disclosure is directed to a base station configured to perform at least part of one or more of the above-discussed embodiments. In another aspect, the present disclosure is directed to an user equipment (UE) configured to perform at least part of any one or more of the above-discussed embodiments. In another aspect, the present disclosure is directed to an integrated circuit configured to perform at least part of one or more of the above-discussed embodiments. In another aspect, the present disclosure is directed to instructions stored on a non-transitory computer readable storage medium which when executed by a processing device cause the processing device to perform at least part of one or more of the above-discussed embodiments.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method, comprising:
detecting, by a first device comprising a station (STA), an interference event comprising a transmission that will interfere or is interfering with a communication session of the STA by a second device comprising an access point (AP) or another station (STA);
transmitting, by the first device to the second device, an identification of the interference event;
receiving, by the first device from the second device, a selection of an operation mode of a plurality of modes, wherein the selection is responsive to the identified the interference event; and
continuing the communication session, by the first device with the second device, utilizing the selected operation mode.

2. The method of claim 1, wherein the interference event comprises a transmission generated by transmission hardware of the first device.

3. The method of claim 1, wherein the interference event comprises a transmission generated by another device.

4. The method of claim 1, wherein detecting the interference event further comprises detecting, prior to the interference event, that the interfering transmission will occur.

5. The method of claim 1, wherein continuing the communication session utilizing the selected operation mode further comprises reducing, by the first device, a modulation and coding scheme rate for transmissions of the communication session.

6. The method of claim 1, wherein continuing the communication session utilizing the selected operation mode further comprises delaying, by the first device, one or more transmissions for an identified interference duration.

7. The method of claim 1, wherein continuing the communication session utilizing the selected operation mode further comprises at least one of the following:
utilizing, by the first device, a clear channel assessment (CCA) level or maximum allowed transmit power level indicated by the second device for transmissions of the communication session;
utilizing, by the first device, a maximum allowed physical layer protocol data unit (PPDU) indicated by the second device for transmissions of the communication session;
utilizing, by the first device, a preemption operation for physical layer protocol data unit (PPDU) or transmission opportunity (TXOP) transmissions during an identified interference duration; or
utilizing, by the first device, a secondary communication channel.

8. The method of claim 1, wherein the selected operation mode is selected based on a signal strength of the interference event.

9. The method of claim 1, further comprising transmitting, by the first device to the second device, an identification of an end of the interference event.

10. The method of claim 1, wherein the transmission that will interfere or is interfering with a communication session of the first device with a second device is on a first communication channel; and wherein transmitting the identification of the interference event further comprises transmitting the identification using a second communication channel.

11. A first device comprising a wireless station (STA), the device comprising:
a transceiver; and
a processor configured to:
detect an interference event comprising a transmission that will interfere or is interfering with a communication session of the STA by a second device comprising an access point (AP) or another STA;
transmit, via the transceiver to the second device, an identification of the interference event;
receive, via the transceiver from the second device, a selection of an operation mode of a plurality of modes, wherein the selection is responsive to the identified the interference event; and
continue the communication session with the second device utilizing the selected operation mode.

12. The first device of claim 11, wherein the interference event comprises a transmission generated by transmission hardware of the first device.

13. The first device of claim 11, wherein the interference event comprises a transmission generated by another device.

14. The first device of claim 11, wherein the interference event is detected by detecting, prior to the interference event, that the interfering transmission will occur.

15. The first device of claim 11, wherein the communication session is continued utilizing the selected operation mode by reducing a modulation and coding scheme rate for transmissions of the communication session.

16. The first device of claim 11, wherein the communication session is continued utilizing the selected operation mode by delaying one or more transmissions for an identified interference duration.

17. The first device of claim 11, wherein the communication session is continued utilizing the selected operation mode by the processor being configured to perform at least one of the following:
utilize a clear channel assessment (CCA) level or maximum allowed transmit power level indicated by the second device for transmissions of the communication session;
utilize a maximum allowed physical layer protocol data unit (PPDU) indicated by the second device for transmissions of the communication session;
utilize a preemption operation for physical layer protocol data unit (PPDU) or transmission opportunity (TXOP) transmissions during an identified interference duration; or
utilize a secondary communication channel.

18. The first device of claim 11, wherein the selected operation mode is selected based on a signal strength of the interference event.

19. The first device of claim 11, wherein the processor is further configured to transmit, to the second device, an identification of an end of the interference event.

20. The first device of claim 11, wherein the transmission that will interfere or is interfering with a communication session of the first device with a second device is on a first communication channel; and wherein the identification of the interference event is transmitted using a second communication channel.
